(19) United States
(12) Patent Application Publication
(10) Pub. No.: US 2013/0151437 A1
(43) Pub. Date: Jun. 13, 2013

(54) SYSTEMS AND METHODS FOR AN UNDERWRITING PRODUCT PORTAL

(71) Applicants: Russell E. Vance, Downingtown, PA (US); Joseph L. Nespor, Canton, CT (US); James D. Roberts, Avon, CT (US); Michael E. Stevens, Durhan, CT (US)

(72) Inventors: Russell E. Vance, Downingtown, PA (US); Joseph L. Nespor, Canton, CT (US); James D. Roberts, Avon, CT (US); Michael E. Stevens, Durhan, CT (US)

(73) Assignee: THE TRAVELERS INDEMNITY COMPANY, Hartford, CT (US)

(21) Appl. No.: 13/607,629

(22) Filed: Sep. 7, 2012

Related U.S. Application Data
(60) Provisional application No. 61/533,099, filed on Sep. 9, 2011.

(51) Int. Cl. G06Q 40/06

(52) U.S. Cl. CPC G06Q 40/06
USPC 705/36 R

(57) ABSTRACT

Systems, apparatus, interfaces, methods, and articles of manufacture that provide for an underwriting product portal such as, for example, an online portal that provides bond and/or other underwriting product pricing, sales, and/or management services.

### CROSS-REFERENCE To RELATED APPLICATIONS

The present application is a non-provisional of, and claims benefit and priority under 35 U.S.C. §119(e) to, U.S. Provisional Patent Application No. 61/533099 filed on Sep. 9, 2011 and titled “SYSTEMS AND METHODS FOR AN UNDERWRITING PRODUCT PORTAL”, the entirety of which is hereby incorporated by reference herein.

### BACKGROUND OF THE INVENTION

Online tools for pricing and selling underwriting products, such as bonds, have increased in usage. Existing tools have failed, however, to provide adequate ease of user navigation, simplicity and ease of issuance/sale, efficient product servicing, ease of viewing and flexibility of searching, and convenience of support services and options. These and other deficiencies of existing underwriting product tools reduce the effectiveness and efficiency of product sales, and accordingly cause a decrease in potential revenues.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a flow diagram of a method according to some embodiments;

FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, and FIG. 4Q are example interfaces according to some embodiments;

FIG. 5A, FIG. 5B, FIG. 5C, FIG. 5D, FIG. 5E, FIG. 5F, FIG. 5G, FIG. 5H, FIG. 5I, FIG. 5J, FIG. 5K, and FIG. 5L are example interfaces according to some embodiments;

FIG. 6 is a flow diagram of a method according to some embodiments;

FIG. 7 is a block diagram of an apparatus according to some embodiments; and

FIG. 8A, FIG. 8B, FIG. 8C, and FIG. 8D are perspective diagrams of example data storage devices according to some embodiments.

### DETAILED DESCRIPTION

Embodiments presented herein are descriptive of systems, apparatus, interfaces, methods, and articles of manufacture for an underwriting product portal. In some embodiments, users of the portal may be able to browse, search, and/or otherwise identify and/or define desired underwriting products such as bond products. According to some embodiments, users may be able to utilize the portal to increase the speed at which bond products may be prepared for sale (e.g., by leveraging stored user preferences, by being provided with pre-filtered menu options, and/or by having preliminary information and/or preference-based information pre-loaded into bond package forms), receive preliminary indications of bond pricing (e.g., instead of requiring completion of a full bond package to discover pricing information), and/or to receive real-time underwriting decisions. In some embodiments, some or all of these features may be provided by a system that utilizes a shared database to provide information to both users and underwriters.

In some embodiments, systems, articles of manufacture (e.g., interfaces), and/or methods may comprise receiving (e.g., by a specially-programmed computerized processing device and/or from a device of a user) preliminary bond information descriptive of a desired bond product, determining (e.g., by the specially-programmed computerized processing device and/or based on the preliminary bond information descriptive of the desired bond product) a price indication for the desired bond product, providing (e.g., by the specially-programmed computerized processing device and/or to the device of the user) an indication of the price indication for the desired bond product, and/or facilitating (e.g., by the specially-programmed computerized processing device and/or after the providing) a sale of the desired bond product.

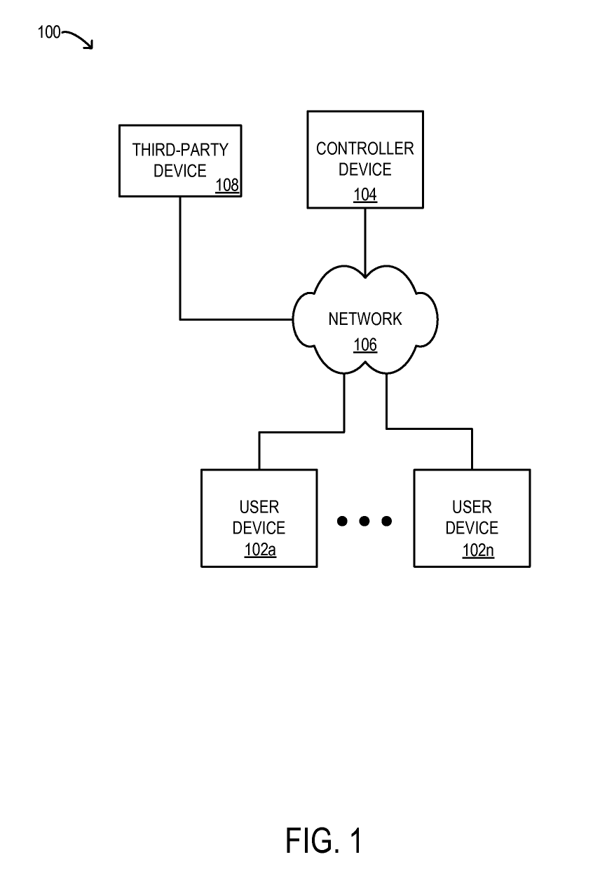

Referring first to FIG. 1, for example, a block diagram of a system 100 according to some embodiments is shown. In some embodiments, the system 100 may comprise a plurality of user devices 102a-n, a controller device 104, a network 106, and/or a third-party device 108. As depicted in FIG. 1, any or all of the devices 102a-n, 104, 108 (or any combinations thereof) may be in communication via the network 106. In some embodiments, the system 100 may be utilized to provide one or more users (not explicitly shown) of the user devices 102a-n with (and/or with access to) a product portal (e.g., an underwriting product and/or bond portal/interface; not explicitly shown in FIG. 1). The controller device 104 may, for example, interface with one or more of the user devices 102a -n and/or the third-party device 108 to provide a product portal for an underwriting product. As utilized herein, the term “underwriting product” may generally refer to any type, quantity, and/or configuration of product and/or service that is underwritten and/or otherwise involves underwriting. Underwriting products may include, but are not limited to, a commercial, business, and/or personal insurance product, surety product, and/or bond product.

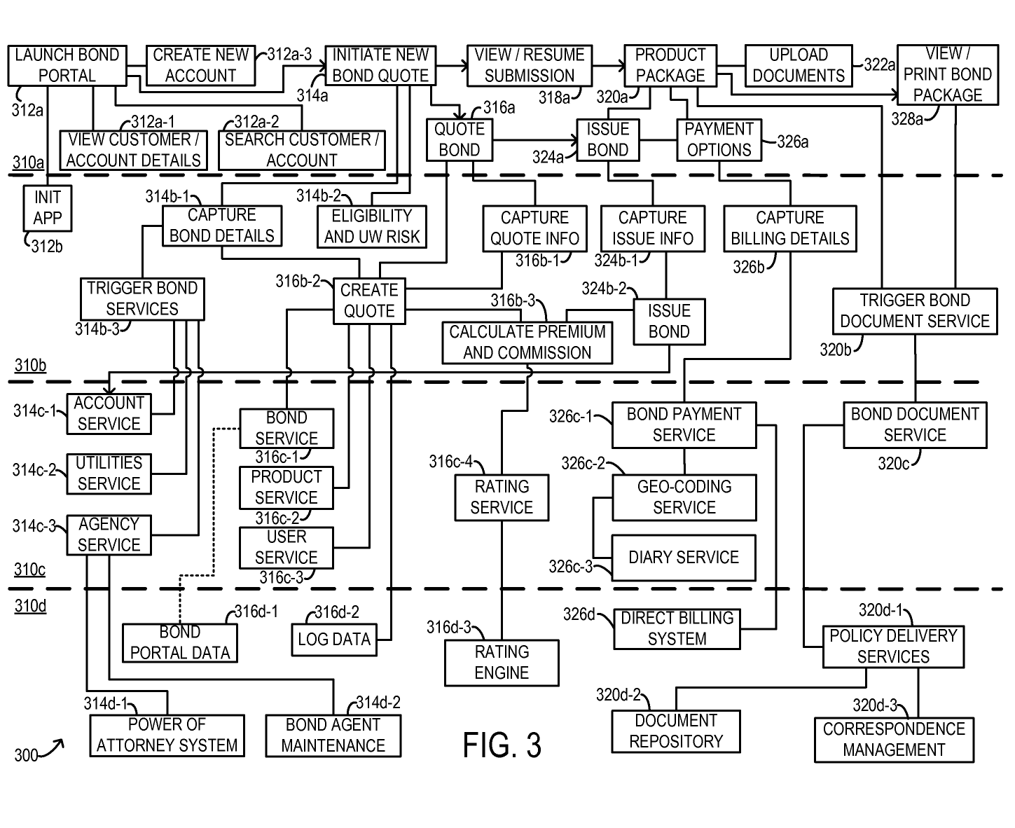

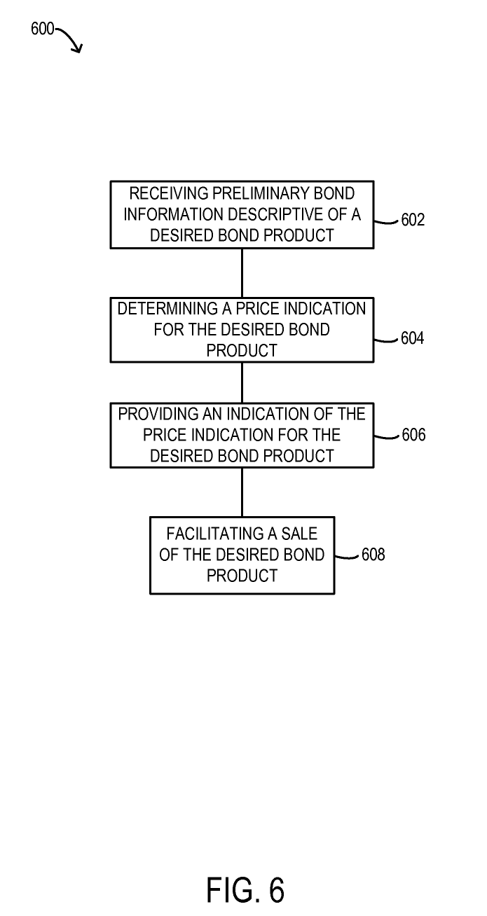

Fewer or more components 102a-n, 104, 106, 108 and/or various configurations of the depicted components 102a-n, 104, 106, 108 may be included in the system 100 without deviating from the scope of embodiments described herein. In some embodiments, the components 102a-n, 104, 106, 108 may be similar in configuration and/or functionality to similarly named and/or numbered components as described herein. In some embodiments, the system 100 (and/or portion thereof) may comprise an underwriting and/or product pricing, sales, and/or management program and/or platform programmed and/or otherwise configured to execute, conduct, and/or facilitate the methods 300, 600 of FIG. 3 and/or FIG. 6 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., underwriter, agent, and/or Customer Service Representative (CSR) workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif.. In some embodiments, the user devices 102a-n may comprise devices owned and/or operated by one or more users such as underwriters, account managers, agents/brokers, CSR, and/or underwriting product customers (e.g., current and/or potential customers).

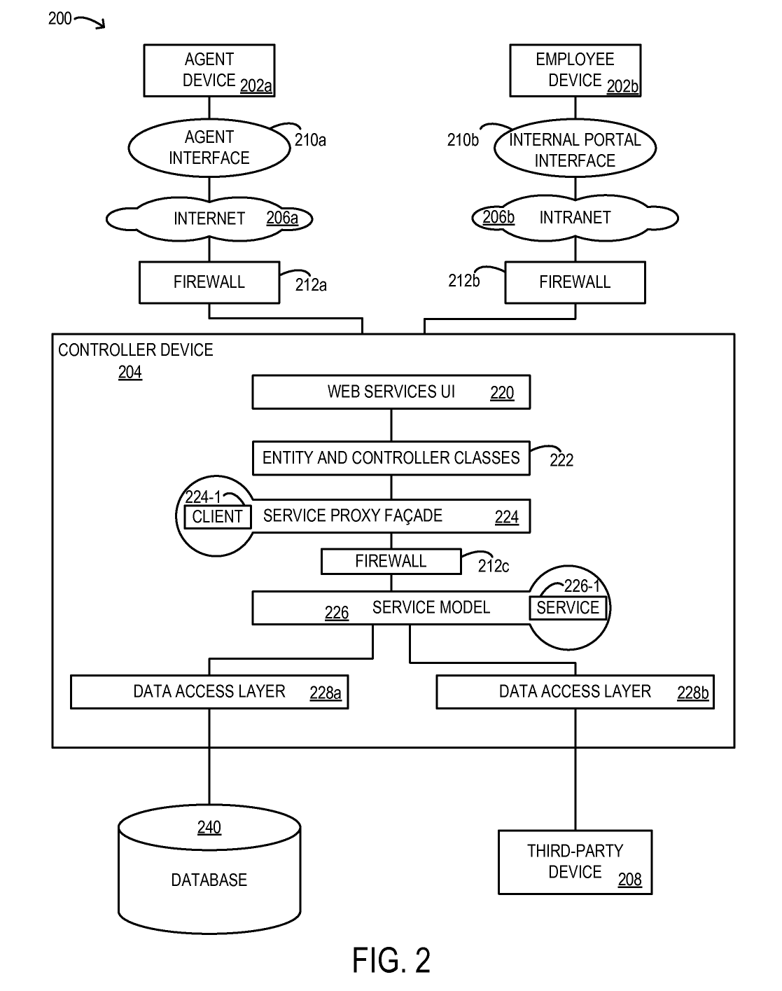

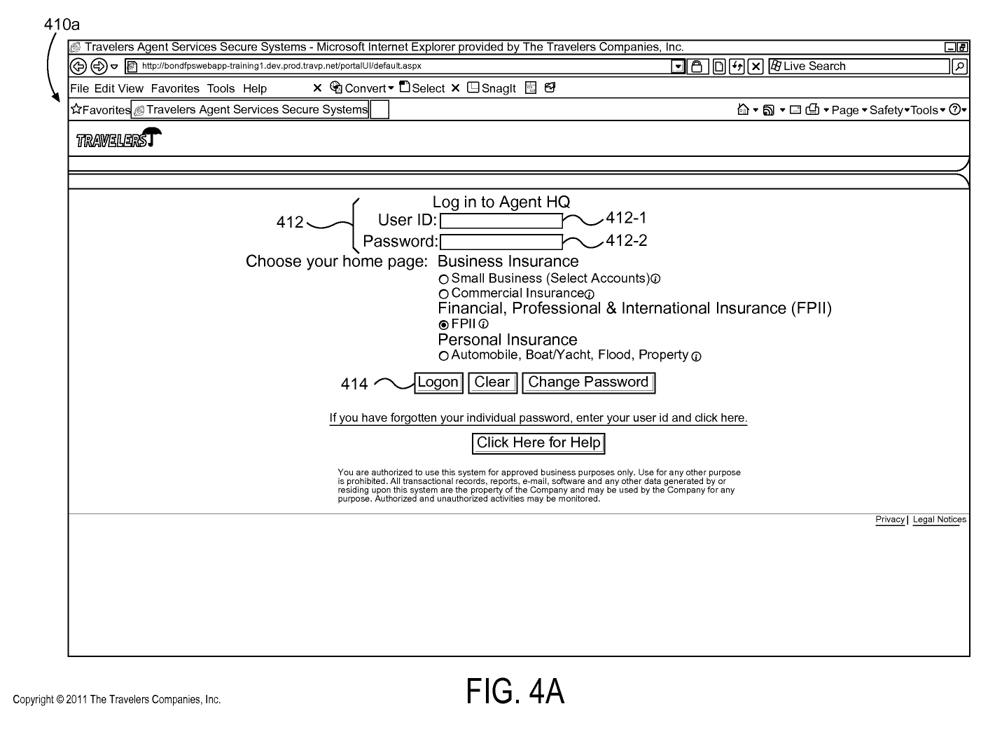

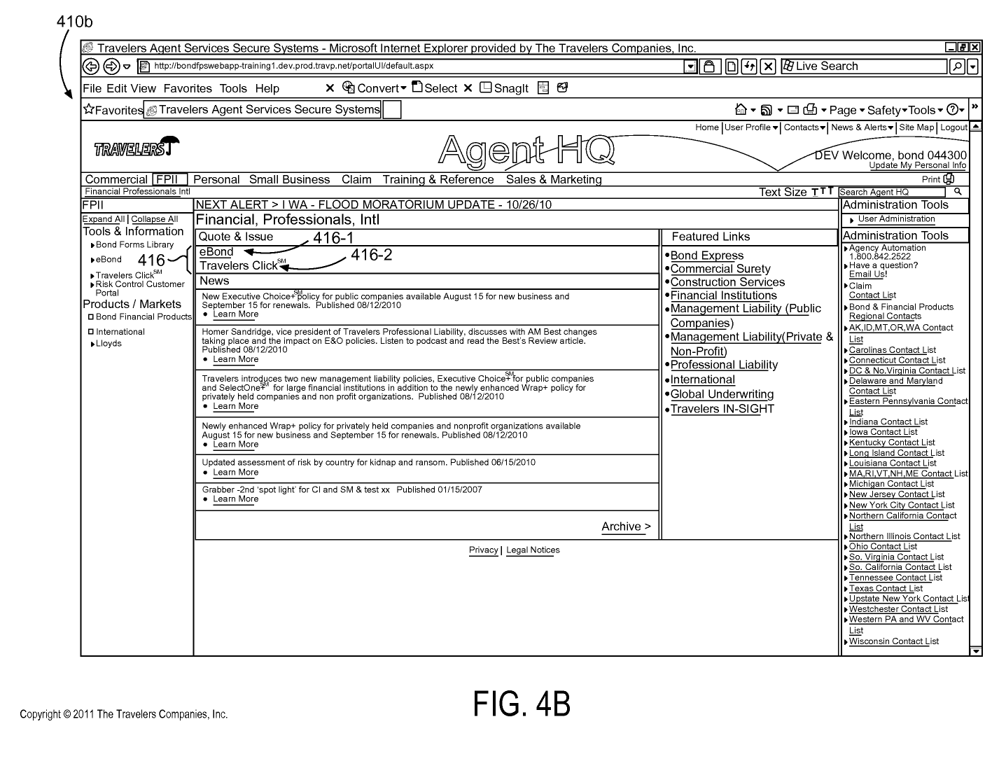

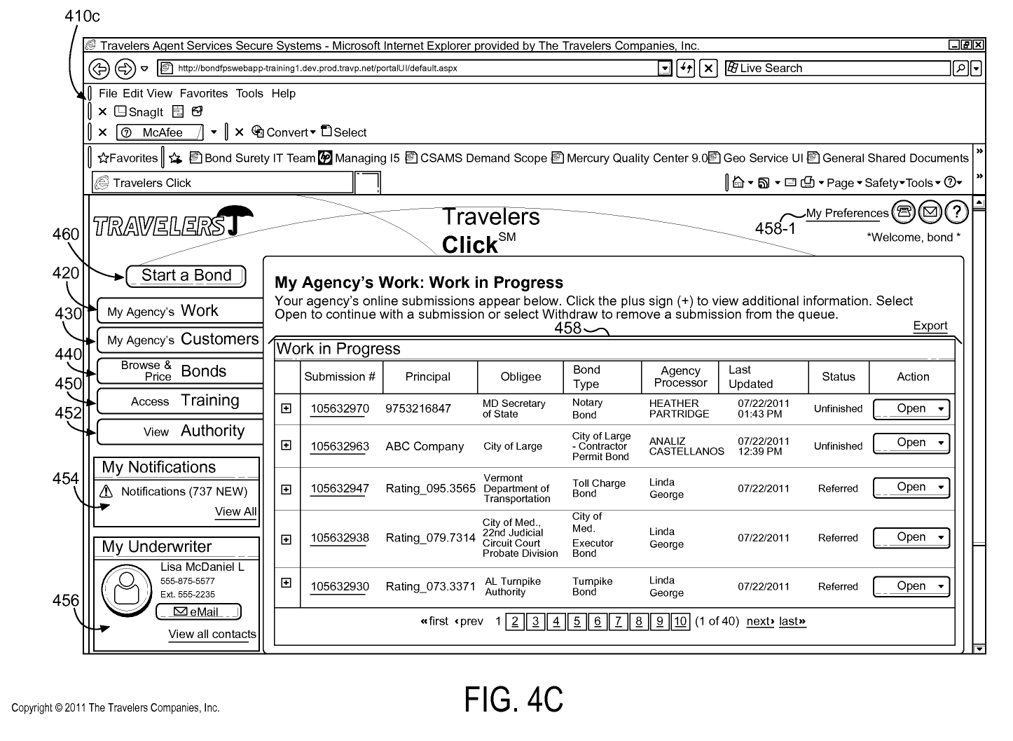

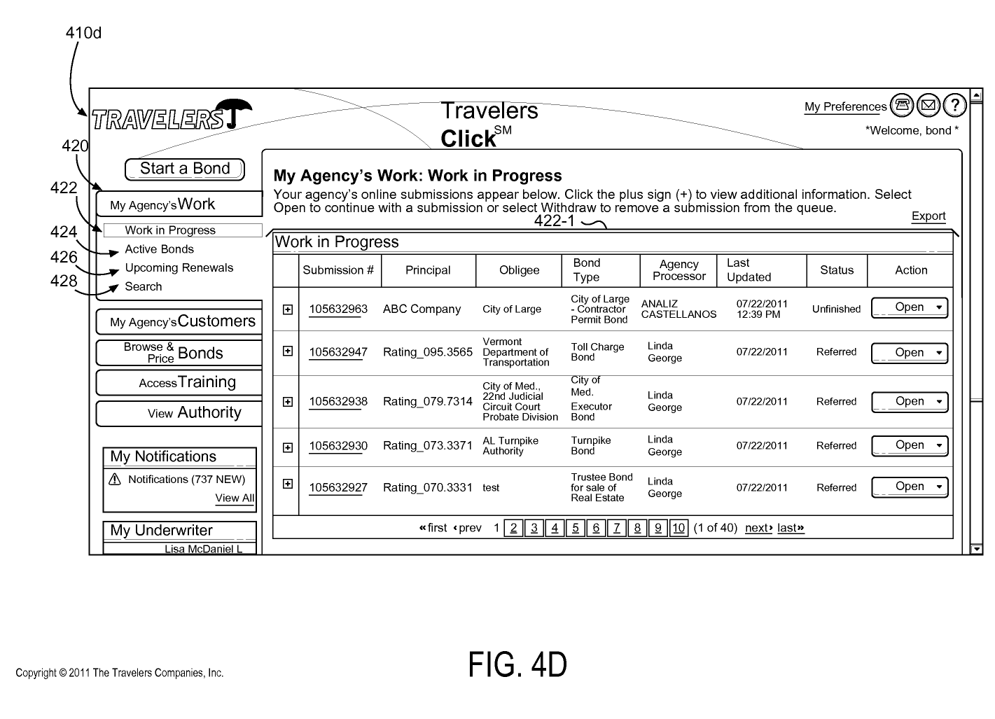

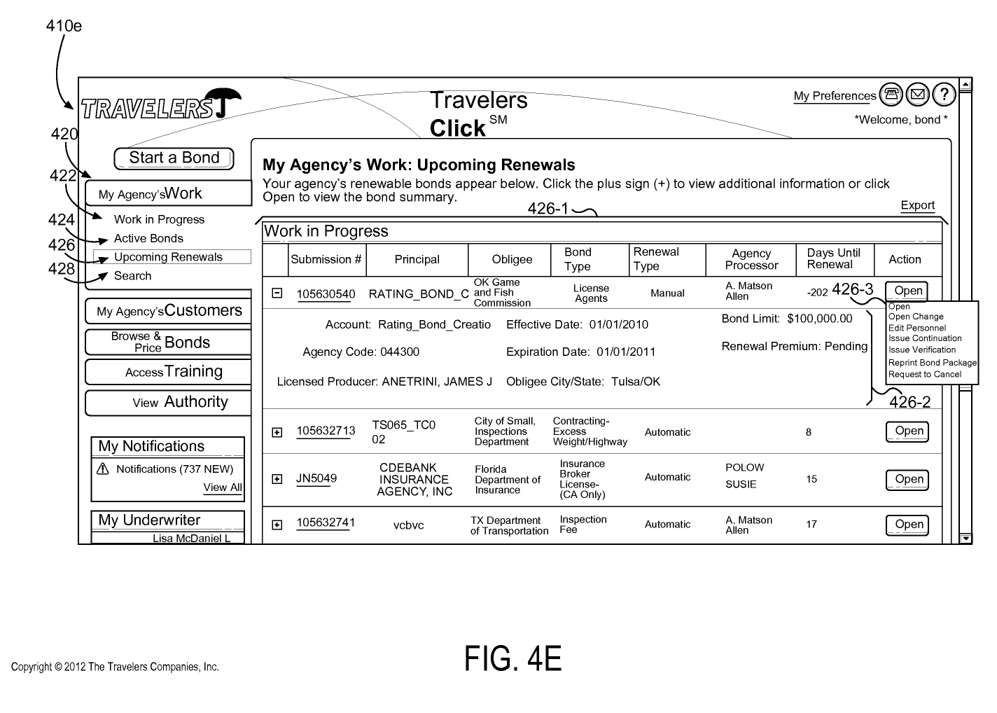

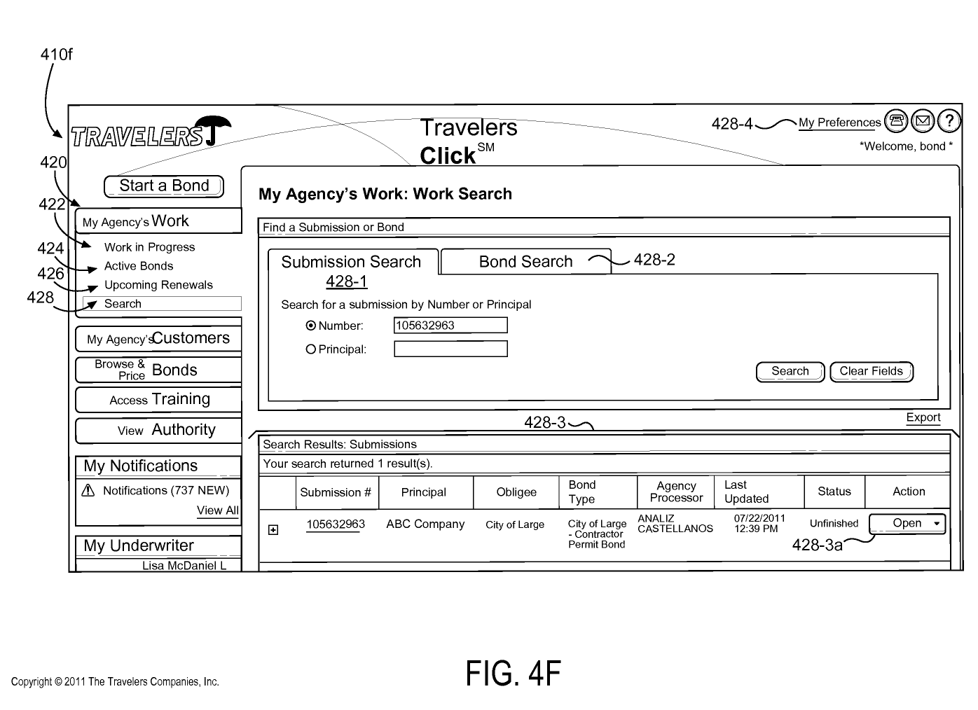

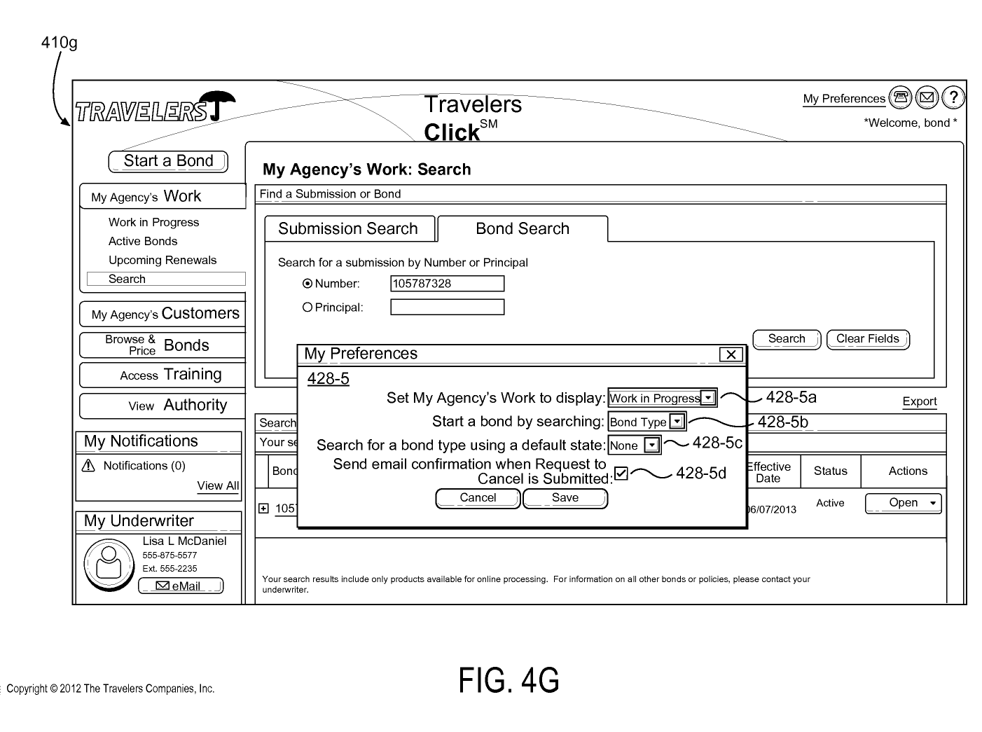

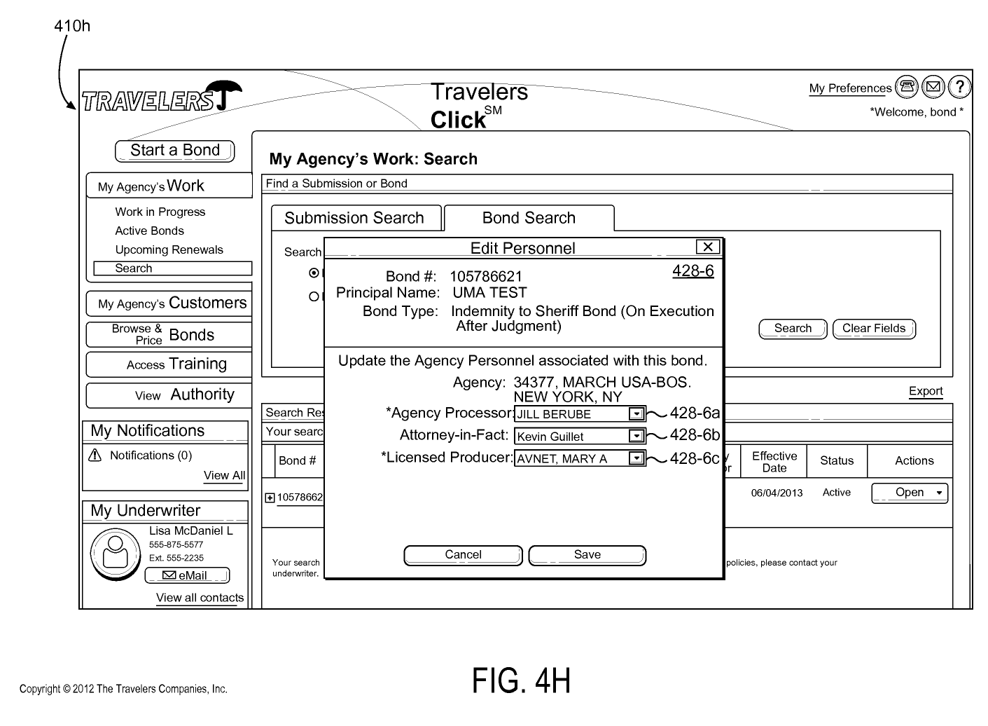

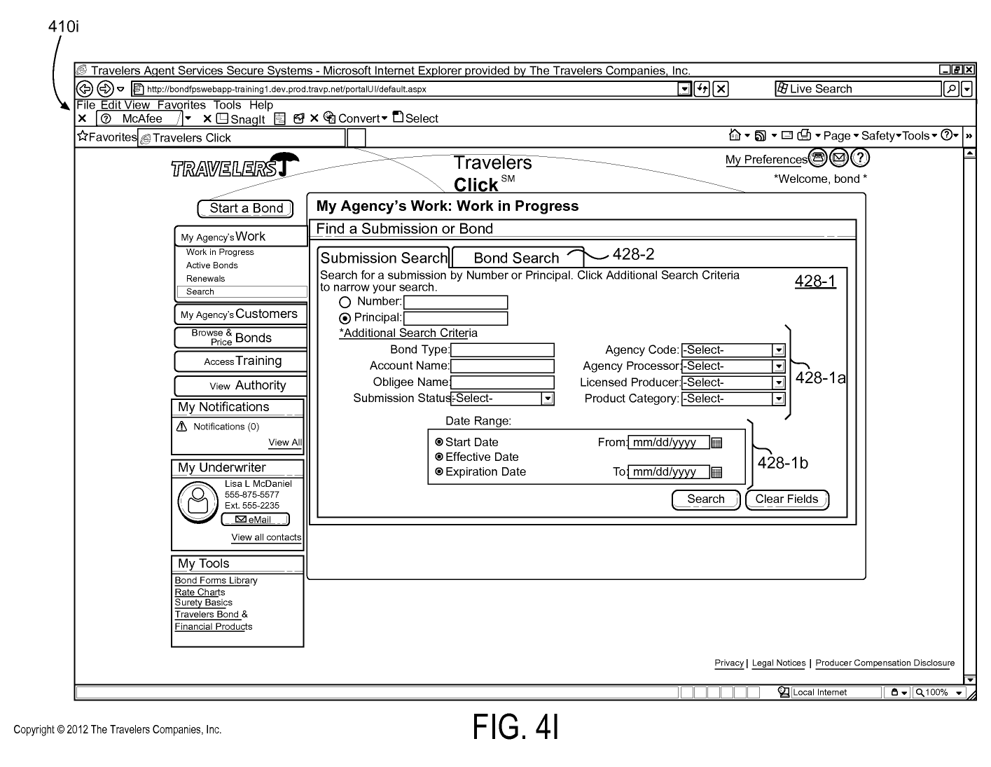

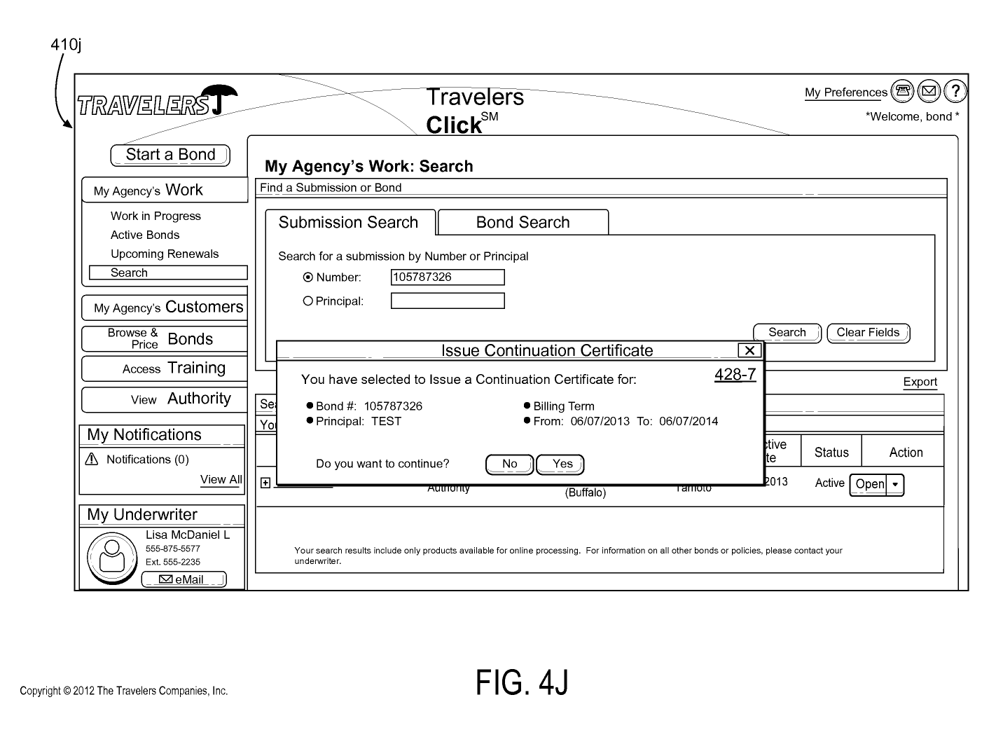

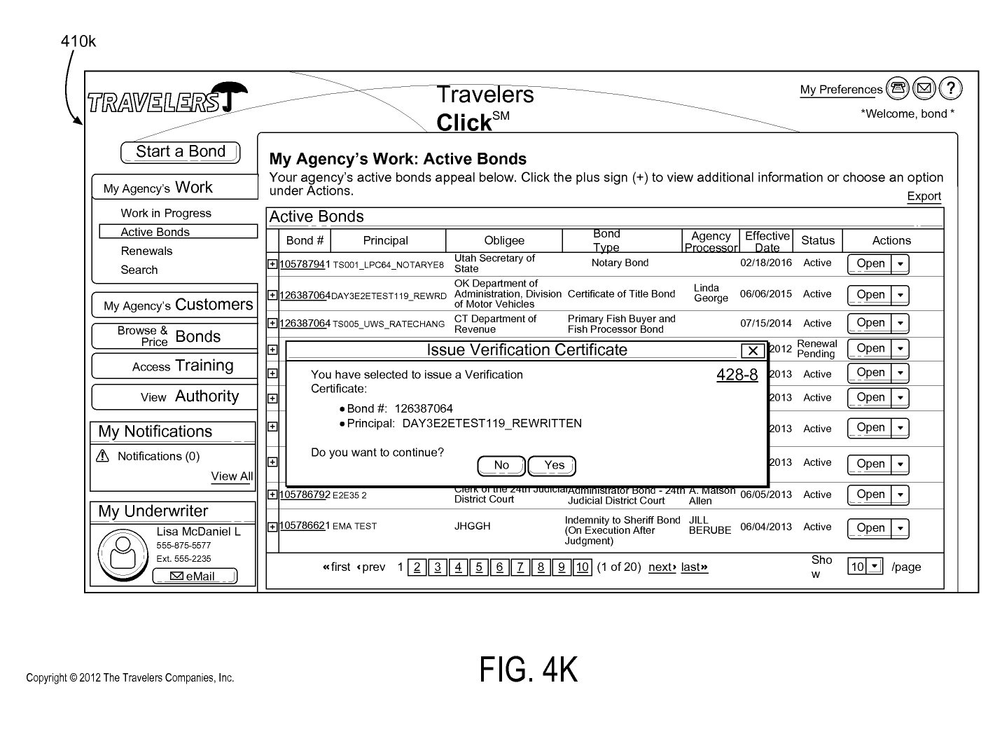

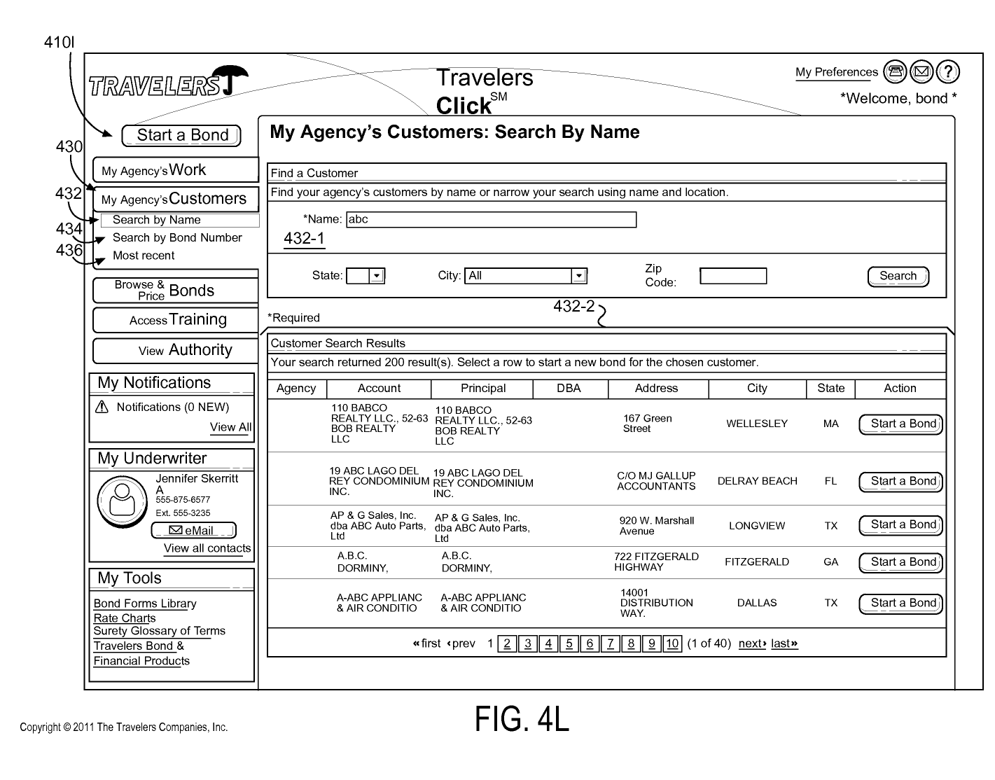

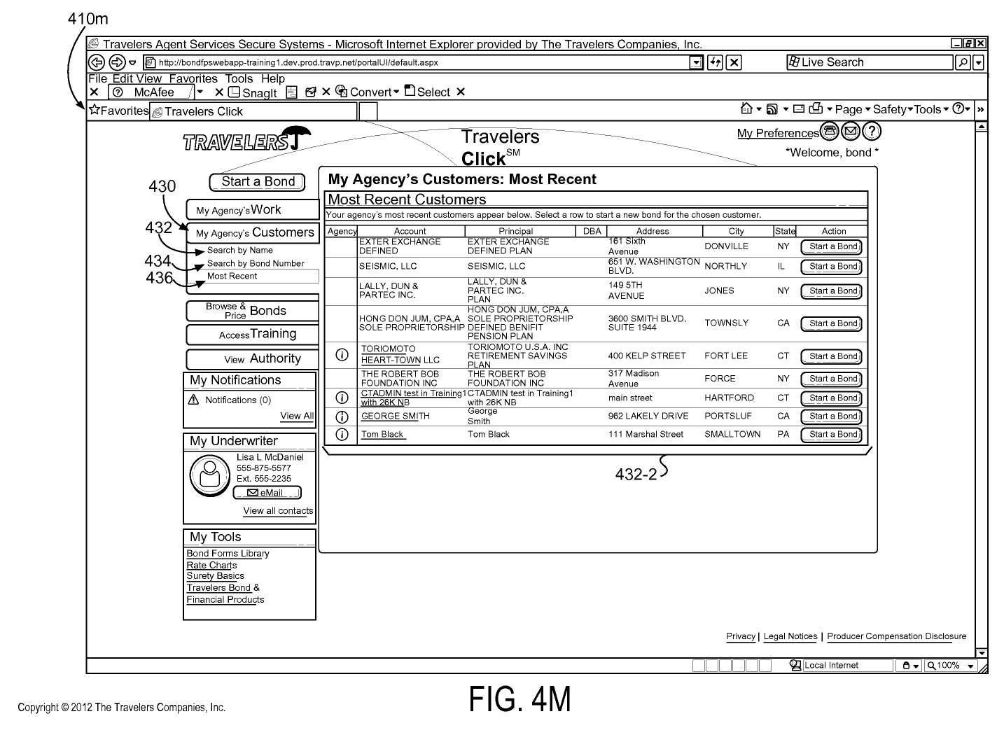

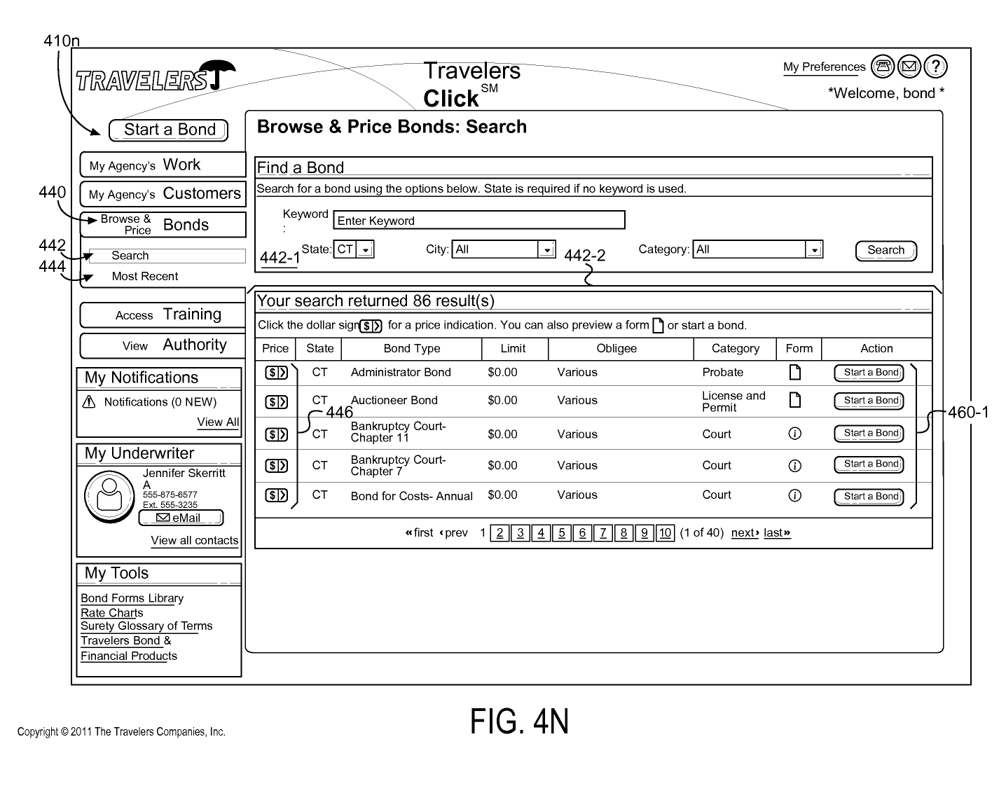

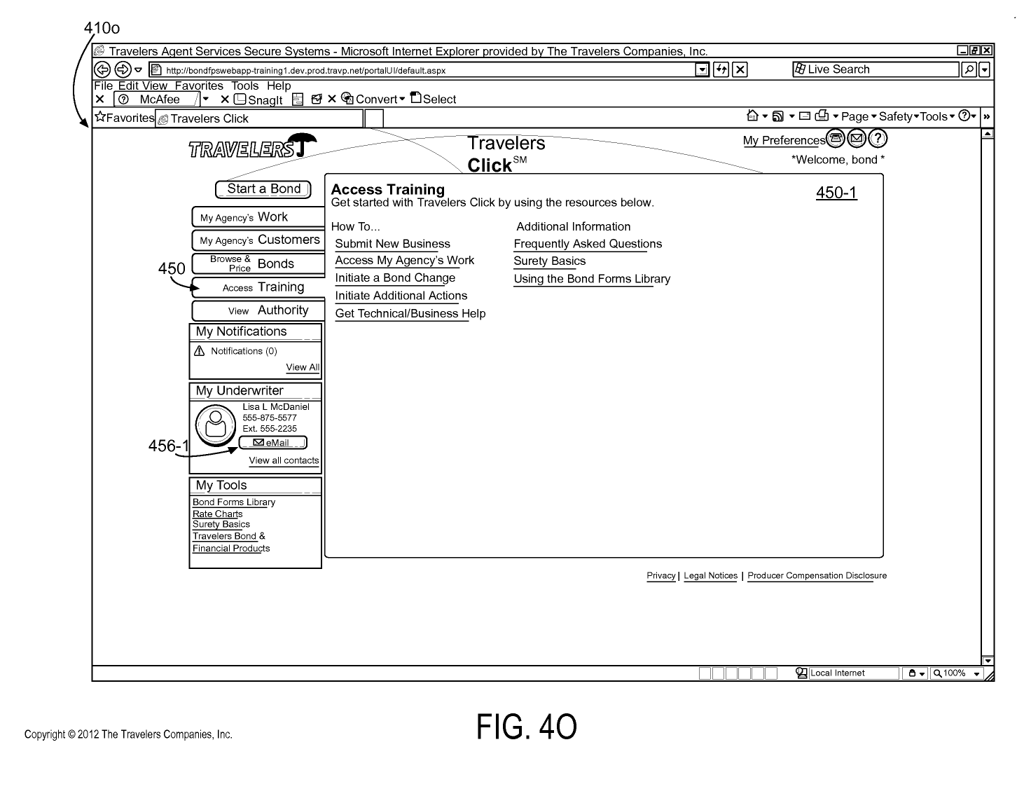

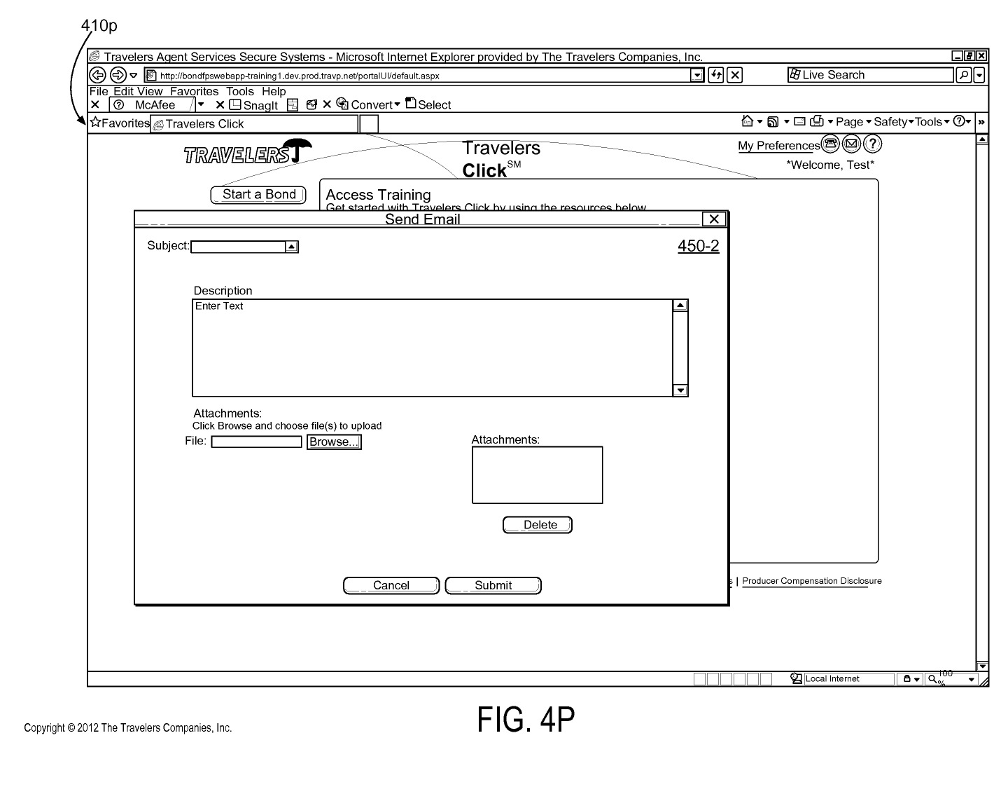

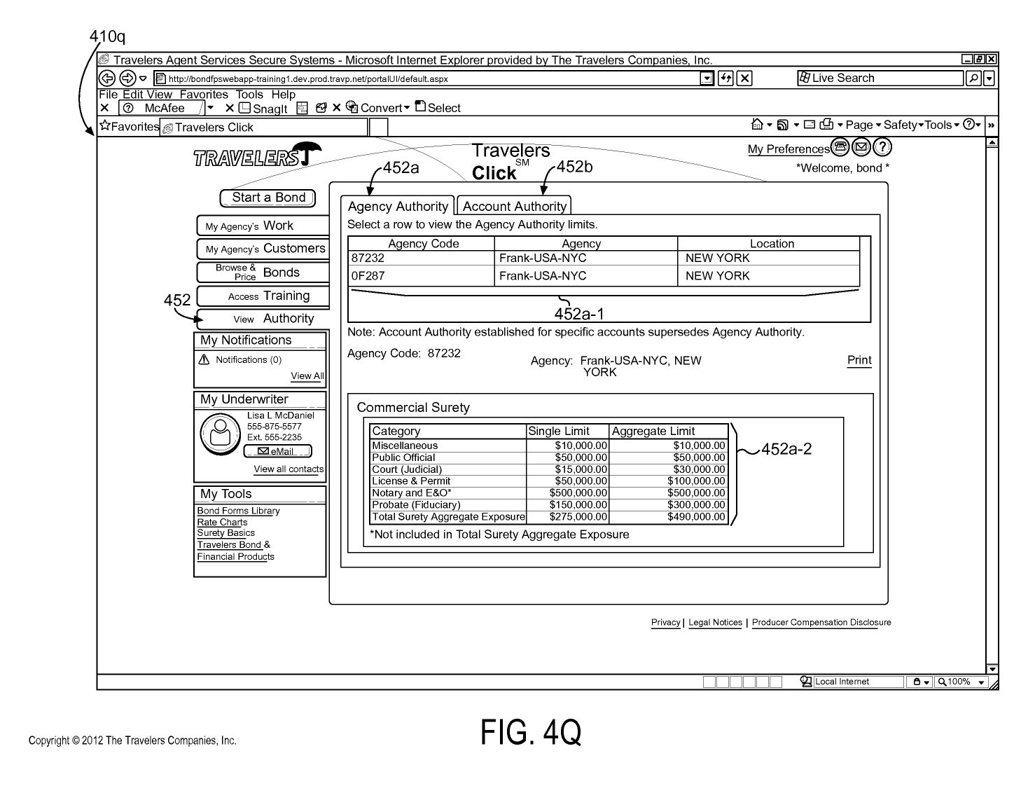

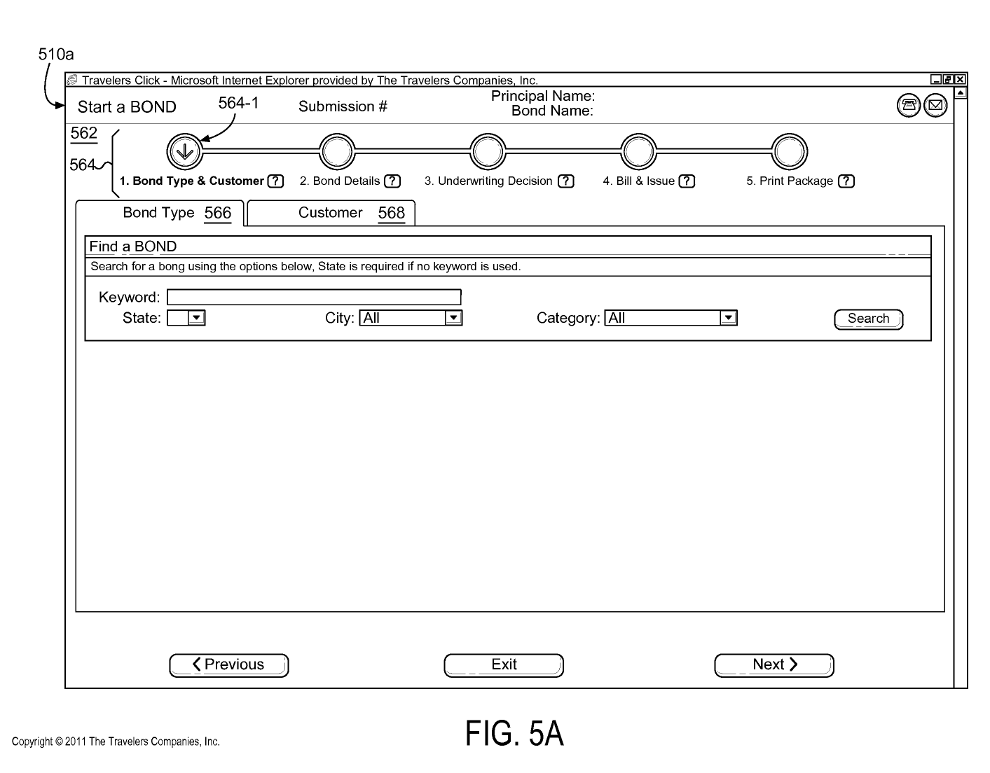

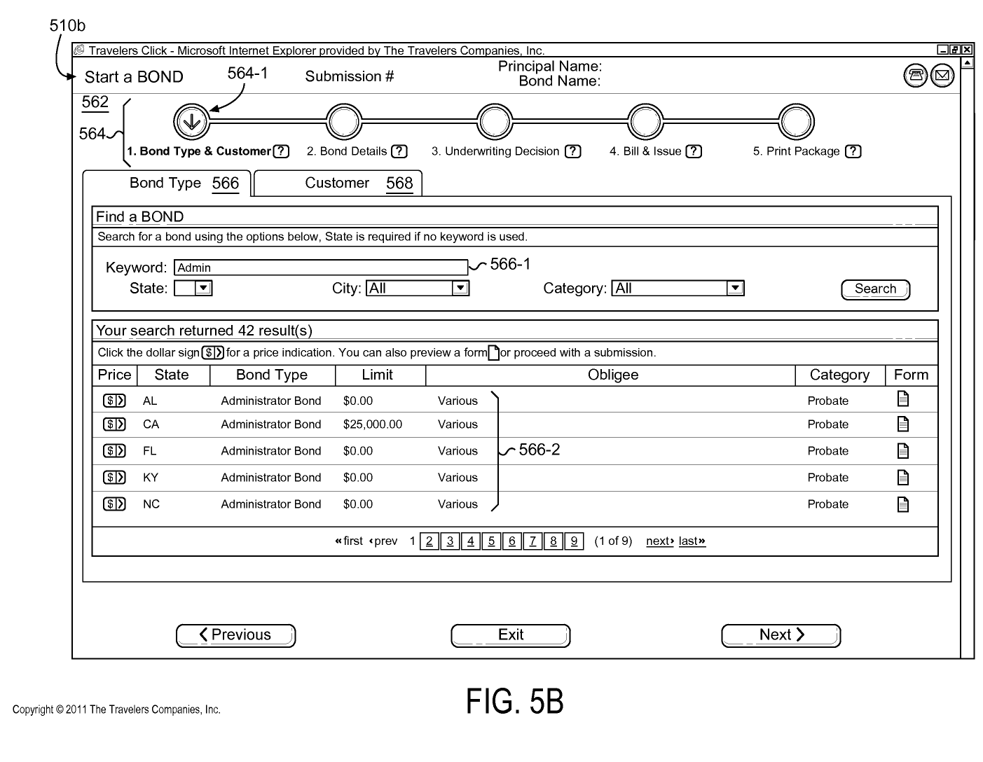

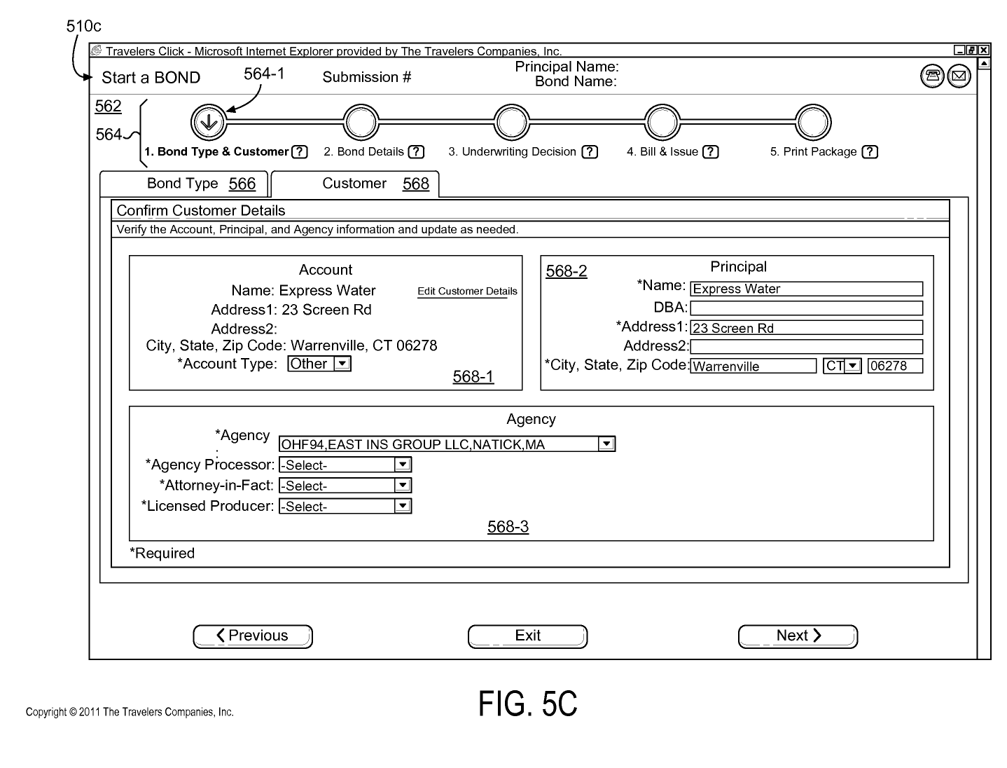

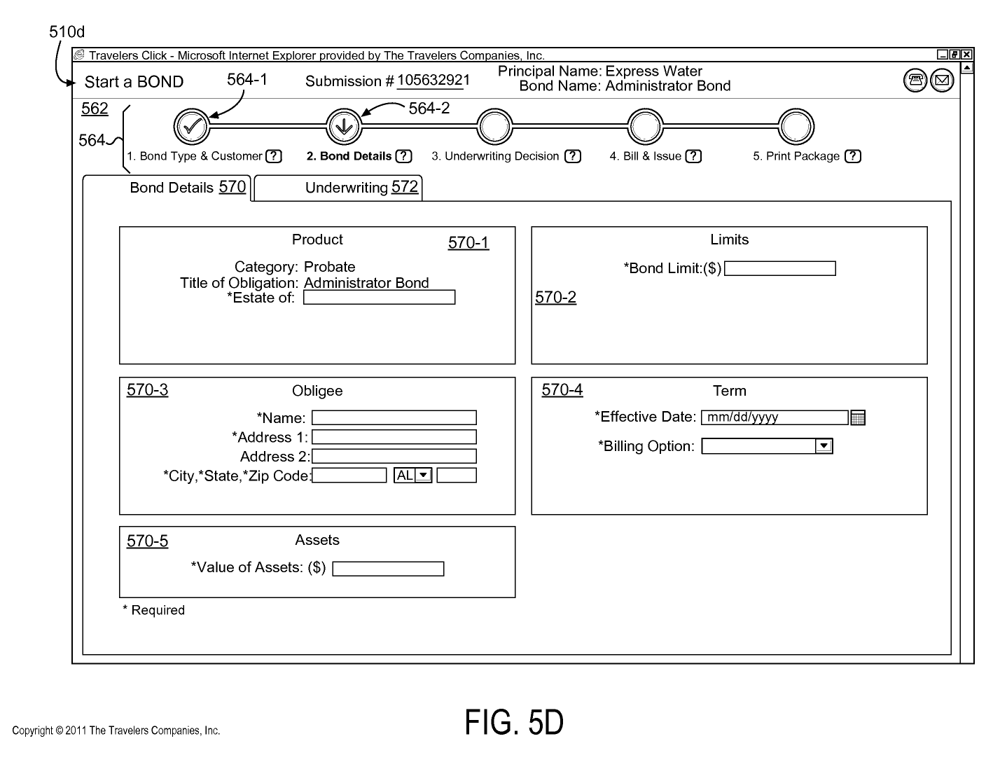

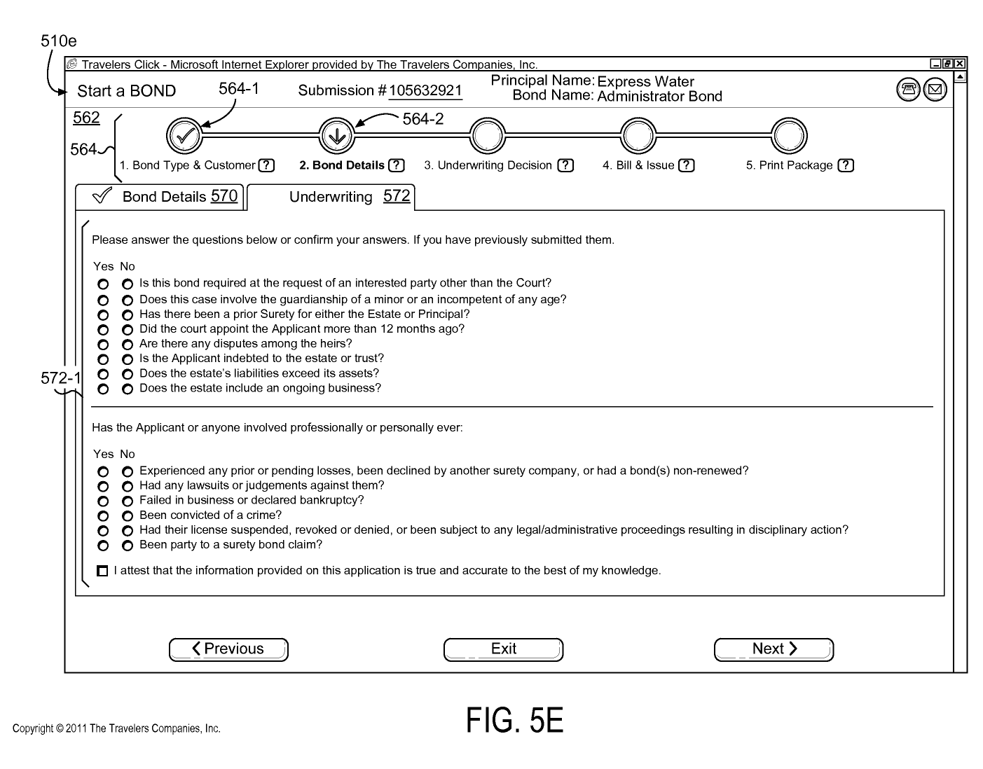

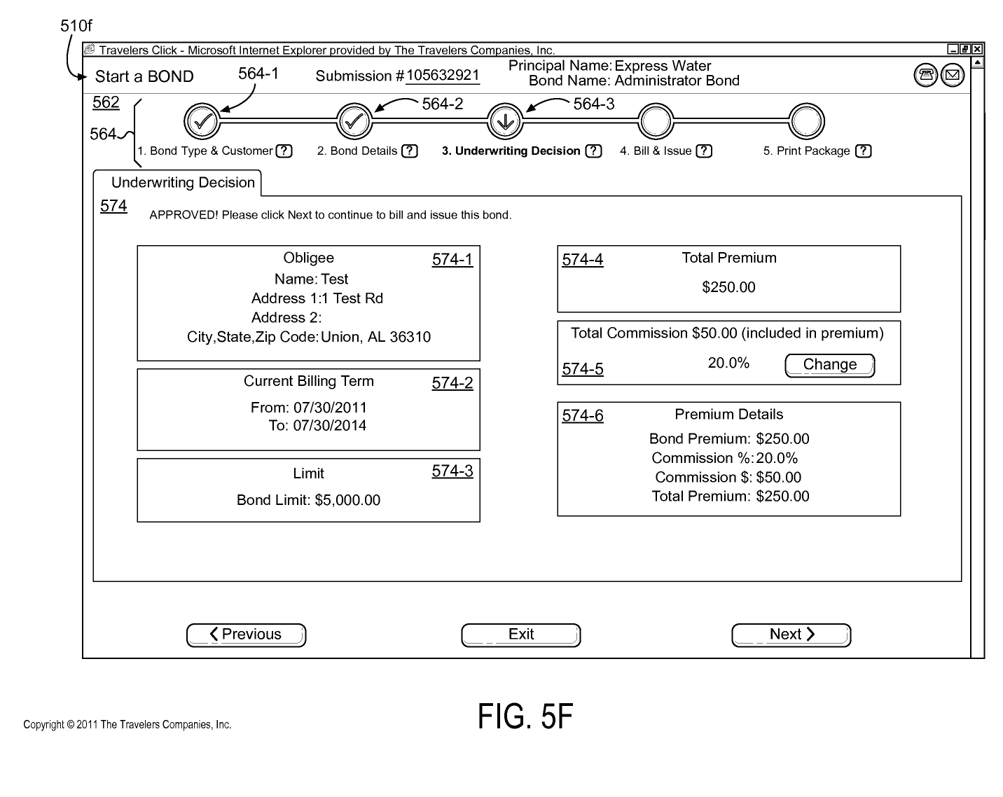

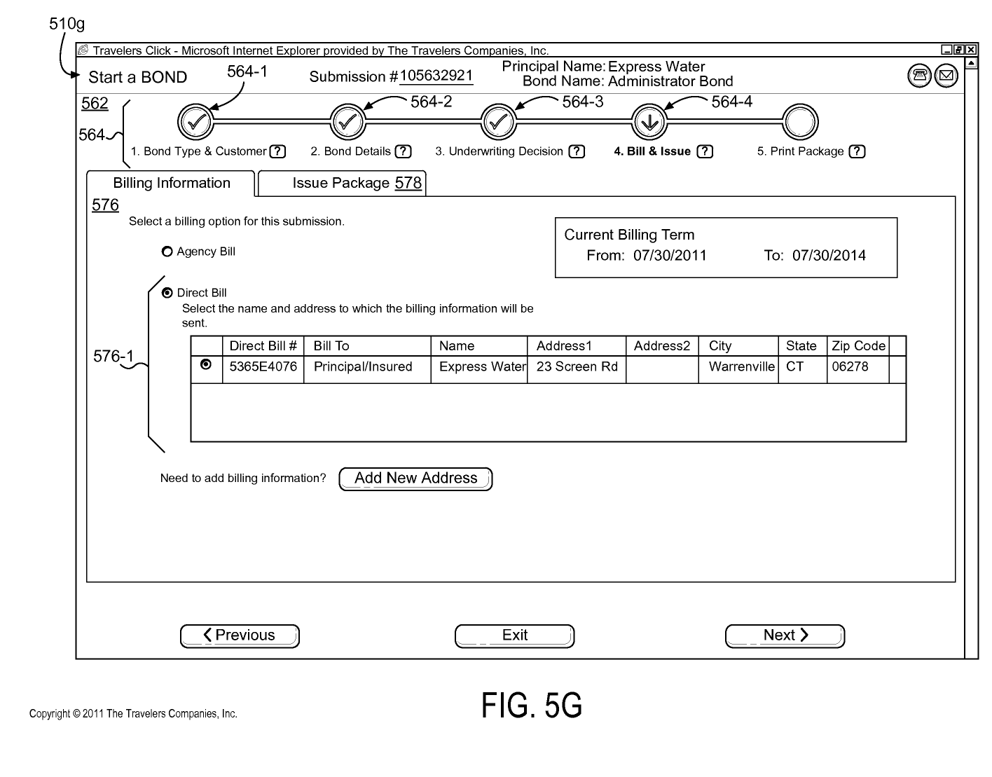

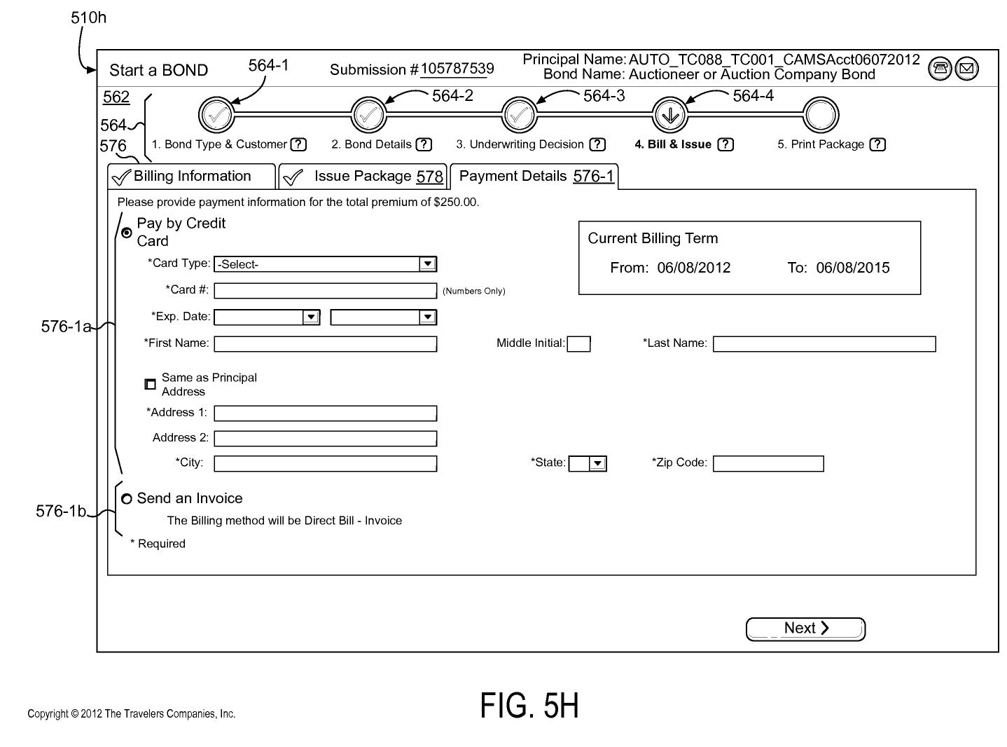

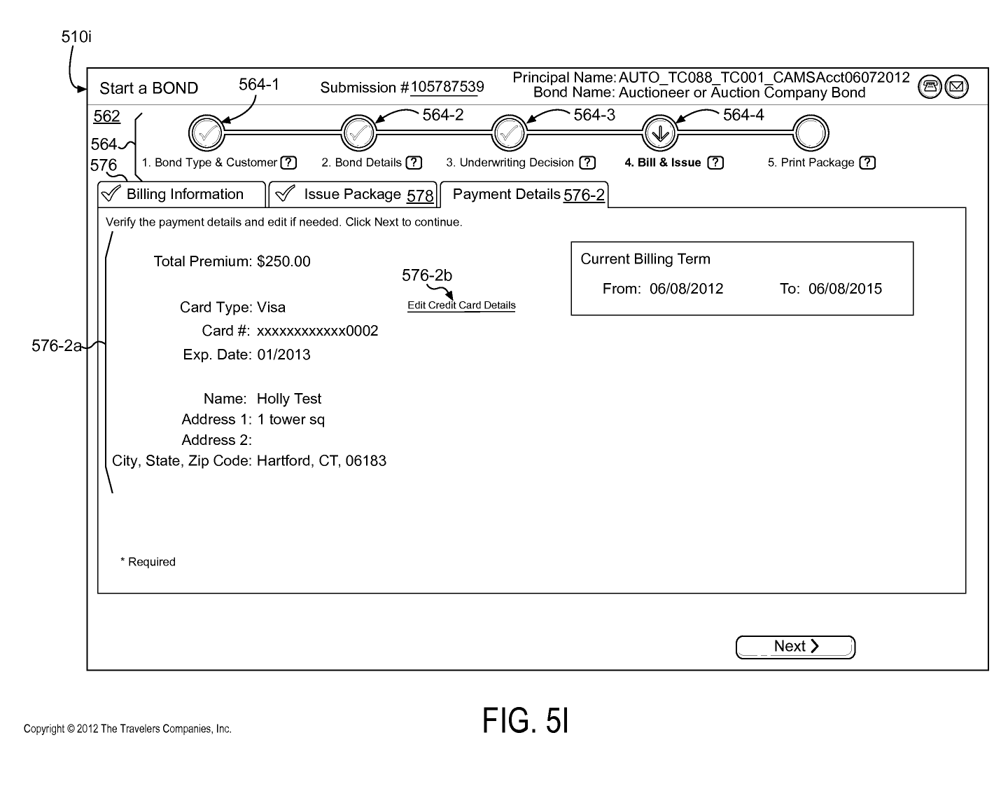

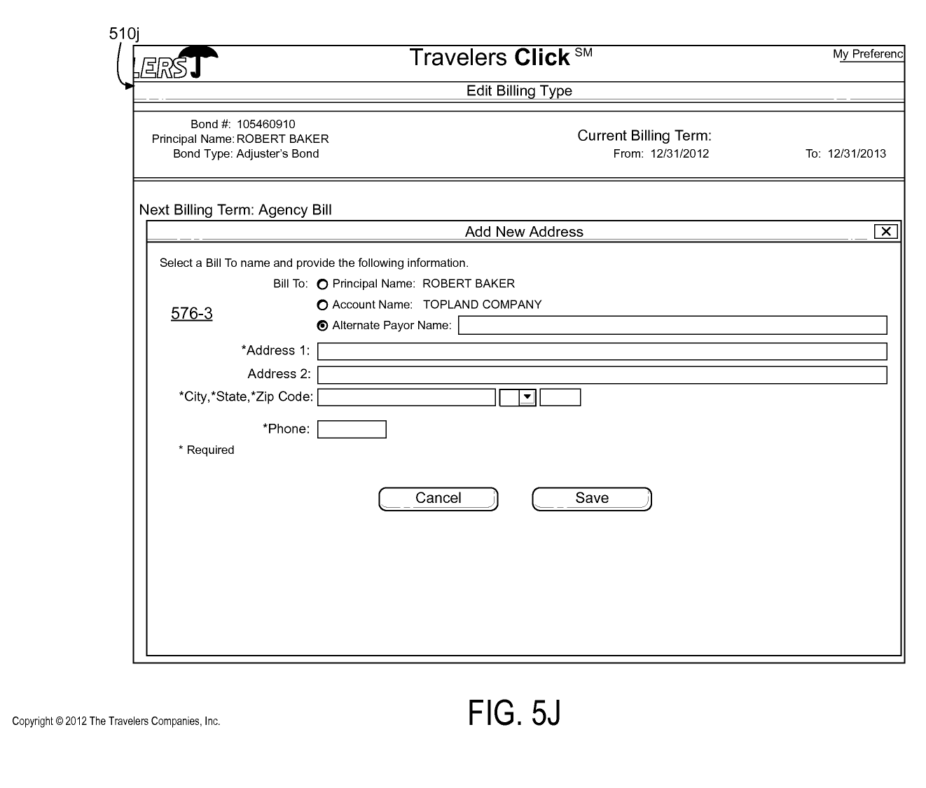

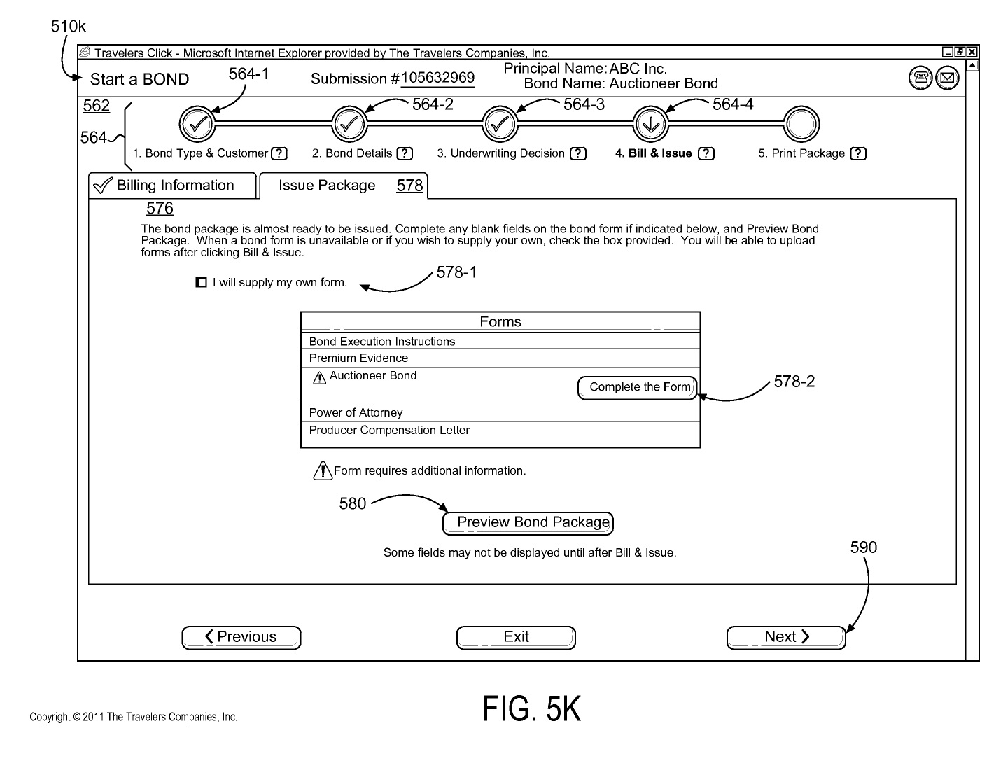

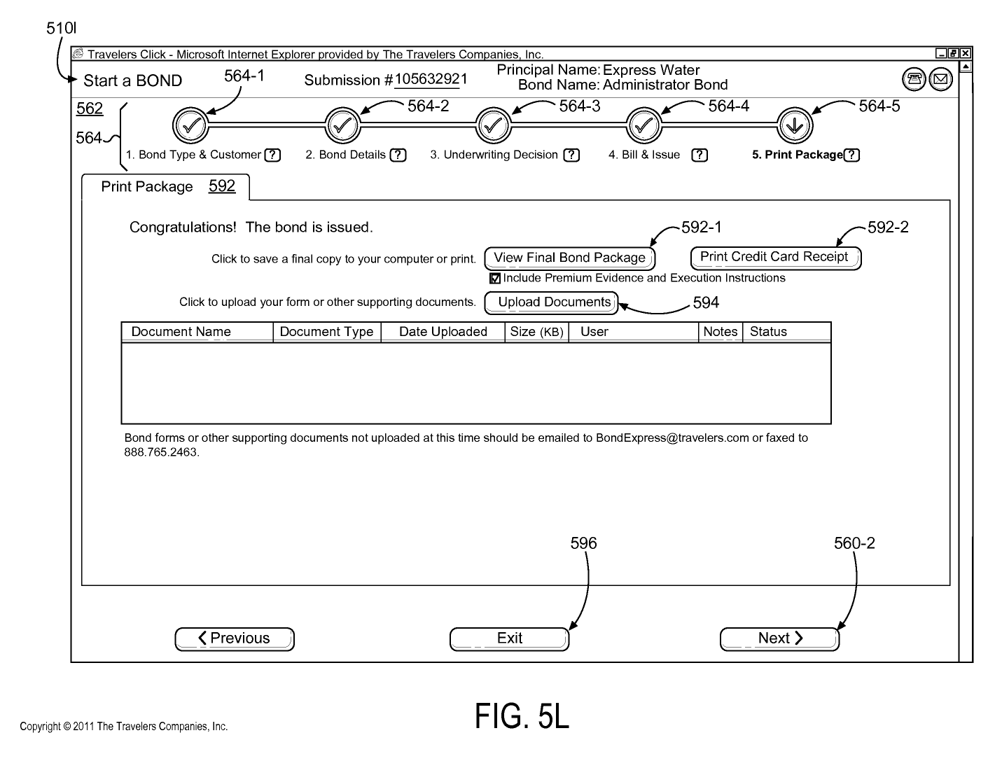

According to some embodiments, the user devices 102a-n may communicate with the controller device 104 via the network 106, such as to conduct underwriting and/or product pricing, sales, and/or management inquiries and/or processes, as described herein. In some embodiments, the user devices 102a-n may communicate with (and/or establish communications with) the controller device 104 utilizing eXtensible Markup Language (XML) and/or third-party (e.g., business-to-business) hyperlinks tags, and/or banners. In such a manner, for example, users (e.g., general users) may authenticate into the controller 104 (and/or an interface such as the interfaces 210a-b, 410a-q, 510a-l of FIG. 2, FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L, herein). In some embodiments, the user devices 102a-n may interface with the controller device 104 to effectuate communications (direct or indirect) with one or more other user devices 102a-n (such communication not explicitly shown in FIG. 1), such as may be operated by other users. In some embodiments, the user devices 102a-n may interface with the controller device 104 to effectuate communications (direct or indirect) with the third-party device 108 (such communication also not explicitly shown in FIG. 1).

According to some embodiments, the controller device 104 may comprise an electronic and/or computerized controller device, such as a computer server, communicatively coupled to interface with the user devices 102a-n and/or the third-party device 108 (directly and/or indirectly). The controller device 104 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 104 may be located remote from one or more of the user devices 102a-n and/or the third-party device 108. The controller device 104 may also or alternatively comprise a plurality of electronic processing devices located at one or more various sites and/or locations.

In some embodiments, the controller device 104 may store and/or execute specially programmed instructions to operate in accordance with embodiments described herein. The controller device 104 may, for example, execute one or more programs that facilitate an underwriting and/or product pricing, sales, and/or management process. According to some embodiments, the controller device 104 may comprise a computerized processing device such as a PC, laptop computer, computer server, and/or other electronic device to manage and/or facilitate transactions and/or communications regarding the user devices 102a-n (e.g., in an attempt to increase the efficiency and/or effectiveness of underwriting and/or product pricing, sales, and/or management processes as described herein). An agent or underwriter (and/or customer, client, or company) may, for example, utilize the controller device 104 to price (and/or pre-price), underwrite, sell, issue, and/or otherwise manage one or more products, such as bond, insurance, indemnity, and/or surety products.

The network 106 may, according to some embodiments, comprise a Local Area Network (LAN; wireless and/or wired), cellular telephone, Bluetooth®, Near-Field Communication (NFC), and/or Radio-Frequency (RF) network with communication links between the controller device 104, the user devices 102a-n, and/or the third-party device 108. In some embodiments, the network 106 may comprise direct communications links between any or all of the components 102a-n, 104, 108 of the system 100. The user devices 102a-n may, for example, be directly interfaced or connected to one or more of the controller device 104 and/or the third-party device 108 via one or more wires, cables, wireless links, and/or other network components, such network components (e.g., communication links) comprising portions of the network 106. In some embodiments, the network 106 may comprise one or more other links and/or network components other than those depicted in FIG. 1. The user devices 102a-n may, for example, be connected to the controller device 104 via various cell towers, routers, repeaters, ports, switches, and/or other network components that comprise the Internet and/or a cellular telephone (and/or Public Switched Telephone Network (PSTN)) network, and which comprise portions of the network 106.

While the network 106 is depicted in FIG. 1 as a single object, the network 106 may comprise any number, type, and/or configuration of networks that is or becomes known or practicable. According to some embodiments, the network 106 may comprise a conglomeration of different sub-networks and/or network components interconnected, directly or indirectly, by the components 102a-n, 104, 108 of the system 100. The network 106 may comprise one or more cellular telephone networks with communication links between the user devices 102a-n and the controller device 104, for example, and/or may comprise the Internet, with communication links between the controller device 104 and the third-party device 108.

The third-party device 108, in some embodiments, may comprise any type or configuration of a computerized processing device such as a PC, laptop computer, computer server, database system, and/or other electronic device, devices, or any combination thereof. In some embodiments, the third-party device 108 may be owned and/or operated by a third-party (i.e., an entity different than any entity owning and/or operating either the user devices 102a-n or the controller device 104). The third-party device 108 may, for example, be owned and/or operated by a credit rating agency, such as Moody's Corporation of New York, N.Y. In some embodiments, the third-party device 108 may supply and/or provide data such as business data, consumer data, credit data, public records, and/or other data to the controller device 104 and/or the user devices 102a-n. In some embodiments, the third-party device 108 may comprise a plurality of devices (e.g., may comprise a plurality of servers and/or databases) and/or may be associated with a plurality of third-party entities.

Turning to FIG. 2, a block diagram of a system 200 according to some embodiments is shown. In some embodiments, the system 200 may conduct and/or facilitate underwriting product pricing (e.g., initial pricing indications and/or quotations, discounting, adjusting, and/or re-pricing), sales, and/or management. The system 200 may, for example, be similar in configuration and/or functionality to the system 100 of FIG. 1 herein. According to some embodiments, the system 200 may comprise one or more user devices 202a-b (such as an agent device 202a and/or an employee device 202b), a controller device 204, one or more networks 206a-b (such as the Internet 206a and/or an intranet 206b), a third-party device 208, one or more user interfaces 210a-b (such as an agent interface 210a and/or an internal portal interface 210b), and/or one or more firewalls 212a-c. In some embodiments, the system 200 and/or the controller device 204 may comprise web services 220, entity and controller classes 222, a service proxy facade 224, a service model 226, and/or one or more data access layers 228a-b. In some embodiments, the system 200 may comprise a database 240.

Fewer or more components 202a-b, 204, 206a-b, 208, 210a-b, 212a-c, 220, 222, 224, 226, 228a-b, 240 and/or various configurations of the depicted components 202a-b, 204, 206a-b, 208, 210a-b, 212a-c, 220, 222, 224, 226, 228a-b, 240 may be included in the system 200 without deviating from the scope of embodiments described herein. In some embodiments, the components 202a-b, 204, 206a-b, 208, 210a-b, 212a-c, 220, 222, 224, 226, 228a-b, 240 may be similar in configuration and/or functionality to similarly named and/or numbered components as described herein. In some embodiments, the system 200 (and/or a portion thereof) may comprise an underwriting and/or product pricing, sales, and/or management program and/or platform programmed and/or otherwise configured to execute, conduct, and/or facilitate the method 300, 600 of FIG. 3 and/or FIG. 6 and/or portions or combinations thereof described herein. In some embodiments, the components 202a-b, 204, 206a-b, 208, 210a-b, 212a-c, 220, 222, 224, 226, 228a-b, 240 of the system 200 may be similar in configuration and/or functionality to similarly named and/or numbered components as described herein.

In some embodiments, the user devices 202a-b may comprise any quantity, type, configuration, and/or combination of processing and/or network devices that are or become known or practicable. The user devices 202a-b may, for example, comprise PC, laptop, tablet, workstation, and/or mobile computing devices utilized to communicate with the user interfaces 210a-b. In some embodiments, the user devices 202a-b may be owned and/or operated by and/or on behalf of and/or may otherwise be associated with or assigned to a customer, potential customer, agent, representative, underwriter, and/or other entity such as any entity desiring to pre-price, price, research, edit, manage, acquire, purchase, and/or otherwise access information related to underwriting products. According to some embodiments, the agent device 202a may comprise a network device of an insurance, bond, and/or other underwriting product agent (not explicitly shown) and/or broker. The agent device 202a may, for example, be utilized to communicate with and/or via the agent interface 210a, which may be connected via the Internet 206a (and/or a first firewall 212a) to the controller device 204. The agent device 202a may comprise a public and/or external device (in relation to the controller device 204), for example, that utilizes the Internet 206a to interface (e.g., via the agent interface 210a) with the controller device 204. According to some embodiments, the agent device 202a may comprise and/or be in communication with an agent database (not explicitly shown) and/or interface or system (also not explicitly shown) such as an independent insurance agent management package available from Applied Systems® of University Park, IL.

In some embodiments, the employee device 202b may comprise a network device of an employee and/or operator of the controller device 204. The employee device 202b may, for example, comprise a private and/or internal device (with respect to the controller device 204 and/or an entity in control thereof) utilized to communicate with and/or via the internal portal interface 210b, which may be connected via the intranet 206b (and/or a second firewall 212b) to the controller device 204. In such a manner, for example, internal/private and/or external/public connections to the controller device 204 may be established, maintained, and/or conducted separately (e.g., for security and/or Quality-Of-Service (QOS) purposes). In some embodiments, the agent interface 210a and the internal portal interface 210b may include different sign-on, login, and/or credential services, applications, and/or features. In some embodiments, the employee device 202b may be operated by an underwriter (e.g., of an underwriting product desired and/or requested by a user of the agent device 202a).

According to some embodiments, the controller device 204 may comprise a computerized and/or electronic device owned and/or operated by or on behalf of or in connection with an insurance and/or other underwriting entity. The controller device 204 may comprise, for example, a server, program (e.g., a web browser plug-in), and/or application (e.g., an underwriting and/or product pricing application) configured to facilitate a product underwriting or pricing process. The controller device 204 may, for example, provide product pricing, selection, sales, and/or management and/or underwriting services for bond, insurance, and/or other underwriting products, as exemplified by the methods 300, 600 (or portions thereof) of FIG. 3 and/or FIG. 6 herein (e.g., by communicating with the user devices 202a-b and/or via the user interfaces 210a-b). According to some embodiments, the controller device 204 may provide the agent interface 210a and/or the internal portal interface 210b via the web services User Interface (UI) 220. The web services UI 220 may, for example, comprise a product portal framework constructed and/or assembled utilizing one or more programming languages and/or tools such as ASP.NET. In some embodiments, the web services UI 220 may be constructed utilizing a proprietary portal framework and/or utilizing one or more third-party and/or Commercially-available Off-The-Shelf (COTS) components such as JavaScript® components, libraries, and/or UI development tools.

In some embodiments, the web services UI 220 may be implemented via entity and controller classes 222. The entity and controller classes 222 may, for example, comprise Object-Oriented Programming (OOP) classes constructed and/or assembled utilizing one or more OOP languages such as VB.NET. In some embodiments, the entity and controller classes 222 may provide an interface layer between the web services UI 220 and the service proxy facade 224, which itself may comprise and/or define one or more clients 224-1 (and/or client requests or calls). In some embodiments, the service proxy facade 224 may communicate with the service model 226 (which may define and/or comprise one or more services 226-1) via a third firewall 212c. The firewalls 212a-c depicted and described herein may be implemented as is or becomes desirable and/or practicable. More or fewer firewalls 212a-c may be utilized in the system 200, for example, and/or one or more of the firewalls 212a-c may be implemented by a single device, component, module, and/or process or may be implemented as multiple stand-alone or interconnected devices, components, modules, and/or processes. According to some embodiments, the clients 224-1 and services 226-1 may be implemented utilizing an Application Program Interface (API) such as Windows Communications Foundation (WCF) provided by Microsoft® Corporation of Redmond, Wash. In some embodiments, the communications through and/or via the third firewall 212c (and/or the third firewall 212c itself) may be implemented via Transmission Control Protocol (TCP).

According to some embodiments, the service model 226 may communicate with the third-party device 208 and/or the database 240 via the data access layers 228a-b. The first data access layer 228a may comprise, for example, an ADO.NET database access layer that utilizes Open Data-Base Connectivity (ODBC) communications protocols to access, retrieve data from, and/or otherwise communicate with the database 240. In some embodiments, the second data access layer 228b may comprise a VB.NET wrapper configured to communicate with the third-party device 208 (e.g., utilizing an API native to the third-party device 208). According to some embodiments, the first data access layer 228a (and/or a different component and/or module or device) may facilitate transmission, mapping, uploading, and/or downloading of data from the database 240 to the agent device 202a and/or a database and/or system thereof (not explicitly shown).

In some embodiments, the third-party device 208 may comprise one or more electronic devices owned and/or operated by or in association with one or more third-parties (not explicitly shown) such as data service providers, credit rating agencies, geo-coding entities, etc. The third-party device 208 may, for example, comprise a server, database, and/or communications module via which data and/or rules regarding underwriting product sales and/or procedures may be obtained (e.g., by the controller device 204). In some embodiments, risk ratings, demographics, and/or other information may be identified and/or obtained based on the input and/or request from the user. The controller device 204 may, for example, receive a response from the third-party device 208 and/or via the data access layers 228a-b (e.g., based on a service request sent from the controller device 204 to the third-party device 208).

In some embodiments, the user interfaces 210a-bmay comprise one or more Graphical User Interfaces (GUI), such as web pages, forms, and/or API modules and/or tools provided by (and/or otherwise associated with) the controller device 204 and/or the third-party device 208 (such as the example interfaces 410a-q, 510a-l of FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L, herein). According to some embodiments, a user (not explicitly shown) may provide input (e.g., a request or client request) via the user devices 202a-b and/or the user interfaces 210a-b. The input may comprise, for example, indications of desired underwriting products, one or more requests for application services, and/or indications of user information such as identification information, credentials for login, etc. In some embodiments, the controller device 204 may receive and/or process the input to provide the web services UI 220. Input received from and/or via the user devices 202a-b and/or user interfaces 210a-b may, for example, be passed from the web services UI 220 and through/via the entity and controller classes 222 and/or the service proxy façade 224 to the service model 226. The service model 226 may then, for example, utilize one or more of the data access layers 228a-b to access, query, leverage, and/or otherwise communicate with the third-party device 208 and/or the database 240 to process the input/request.

According to some embodiments, the database 240 may comprise any type, quantity, and/or configuration of device(s), data store(s), computer-readable media, computer-readable memory, and/or network component(s) operable and/or configured to store information. In some embodiments, the database 240 may be owned and/or operated by a third-party entity (and/or a plurality of third-parties; e.g., similar to the third-party device 208; the entity not being explicitly shown). Such a third-party entity may, in some embodiments, comprise a commercial service that acquires, aggregates, provides, and/or sells access to various information such as demographics, marketing information, credit ratings (and/or other credit and/or financial information), and/or business classifications (such as Standard Industrial Classification (SIC) codes as published by the U.S. Occupational Health & Safety Administration (OSHA) and/or North American Industrial Classification System (NAICS) codes) data. In some embodiments, the database 240 may be local and/or internal to the controller device 204 and/or may store proprietary, private, and/or localized information. The database 240 may, for example, be owned and/or operated by an entity that also owns and/or operates the controller device 204 (e.g., an insurance and/or underwriting product provider). In some embodiments, the database 240 may be considered to be a “shared” database, such that information stored therein may be accessible to both the agent device 202a (e.g., and an insurance agent and/or customer associated therewith) and the employee device 202b (e.g., and an underwriter associated therewith).

According to some embodiments, any program code, rules, communications protocols, and/or definitions, modules, objects, classes, and/or any combination thereof that cause and/or facilitate operation of the controller device 204 and/or the user interfaces 210a-b, may be managed, defined, edited, and/or stored via an API program, plug-in, application, module, and/or device (not shown in FIG. 2). The API device may, for example, comprise a specially-programmed API, program, application, and/or other function or procedure that facilitates creation, setup, and/or execution or management of an underwriting and/or underwriting product pricing, sales, and/or management tool.

Turning to FIG. 3, a flow diagram of a method 300 according to some embodiments is shown. In some embodiments, the method 300 may be performed and/or implemented by and/or otherwise associated with one or more specialized and/or computerized processing devices (e.g., the user devices 102a-n, 202a-b, and/or the controller devices 104, 204, of FIG. 1 and/or FIG. 2), specialized computers, computer terminals, computer servers, computer systems and/or networks, and/or any combinations thereof (e.g., by one or more insurance company, agent/broker, and/or bond or surety underwriter computers). In some embodiments, the method 300 may be embodied in, facilitated by, and/or otherwise associated with various input mechanisms and/or interfaces such as the user interfaces 210a-b, 410a-q, 510a-l described with respect to FIG. 2, FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L herein. The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 300 may be illustrative of a process that occurs when a customer, potential customer, agent, broker, underwriter, and/or other user requests and/or provides information regarding an underwriting product (e.g., a bond product) via an underwriting product portal - while a bond product is utilized in the example of FIG. 3, other underwriting products may also or alternatively be utilized in the method 300. According to some embodiments, the method 300 may be illustrative of a process of self-service product pricing, sales, and/or management (such as an agent or broker pricing and selling a bond product online). In some embodiments, the method 300 may comprise processes and/or procedures or functions performed by various elements, systems, and/or entities and/or via different contexts. As depicted by the dashed lines in FIG. 3, for example, the method 300 may be performed via four (4) distinguishable elements 310a-d: (i) a user element 310a; (ii) a portal element 310b; (iii) a services element 310c; and/or (iv) an external element 310d.

In some embodiments, the user element 310a may comprise launching a bond portal at 312a. An existing and/or previous user may, for example, enter credentials and view customer/account details at 312a-1 and/or search for customer/account information at 312a-2. New users/customers may create a new account at 312a-3. In some embodiments, an initialization application at 312b may be called to cause and/or facilitate the launching of the bond portal at 312a.

According to some embodiments, a bond quote may be initiated at 314a. In some embodiments, the quote may comprise a preliminary estimate, quotation, and/or indication of likely bond cost. Such a preliminary metric may, for example, be based on preliminary product information, such as may be provided by the user (e.g., at 312a and/or 314a). In some embodiments, the portal element 310b may comprise capturing bond details (such as preliminary bond information as described herein) at 314b-1 and/or determining eligibility and/or underwriting risks at 314b-2. According to some embodiments, the capturing of bond details at 314b-1 may cause and/or be followed by a triggering of bond services at 314b-3. In some embodiments, the services element 310c may comprise causing, triggering, initiating, and/or utilizing (e.g., in response to the triggering of the bond services at 314b-3) an account service 314c-1, a utilities service 314c-2, and/or an agency service 314c-3. In some embodiments, the agency service 314c-3 may cause, trigger, and/or initiate (e.g., within the external element 310d) a power of attorney system 314d-1 and/or a bond agent maintenance system 314d-2.

In some embodiments, the user element 310a may comprise (and/or the user may select) a bond quote at 316a. The bond quote may, as described herein, comprise a preliminary estimate and/or indication (e.g., based on preliminary bond information), or may comprise a full quotation provided in response to completion of a full bond package. In some embodiments, the bond quotation at 316a may cause, trigger, initiate, utilize, and/or otherwise be associated with (e.g., in the portal element 310b) a capturing of quote information at 316b-1 and/or a creation of the bond quote at 316b-2. Information captured at 316b-1 and/or at 314b-1 may be utilized, for example, to lookup, estimate, calculate, derive, and/or otherwise determine a quote at 316b-2. In some embodiments, the quote at 316b-2 may be utilized to calculate and/or determine a premium and/or commission at 316b-3. In some embodiments, the quotation at 316b-2 may cause, trigger, initiate, utilize, and/or otherwise be associated with a bond service 316c-1, a product service 316c-2, and/or a user service 316c-3 from the services element 310c and/or bond portal data 316d-1 and/or log data at 316d-2 from the external element 310d. In some embodiments, the calculation of the premium and/or commission at 316b-3 may cause, trigger, initiate, utilize, and/or otherwise be associated with a rating service 316c-4 in the services element 310c and/or a rating engine 316d-3 in the external element 310d.

According to some embodiments, the user may view/review and/or resume a submission (e.g., bond package) at 318a. In some embodiments, a product (e.g., bond) package may be created at 320a. The product package 320a may cause and/or initiate, for example, a triggering of bond document services at 320b in the portal element 310b, which may in turn cause, trigger, initiate, utilize, and/or otherwise be associated with a bond document service 320c in the services layer 310c. According to some embodiments, the bond document services at 320c may cause, trigger, initiate, utilize, and/or otherwise be associated with policy delivery services 320d-1, a document repository 320d-2, and/or correspondence management 320d-3 in the external element 310d.

In some embodiments, the product package at 320a may be defined, edited, and/or supplemented by uploading documents at 322a. The user may upload bond application and/or legal documents, for example, directly into the bond package 320a. In some embodiments, the bond package at 320a may be utilized to issue the bond at 324a and/or the issuance of the bond 324a may define, populate, and/or at least partially construct the bond package at 320a. In some embodiments, the issuance of the bond at 324a may cause, trigger, initiate, utilize, and/or otherwise be associated with a capturing of issue information at 324b-1 and/or a bond issuance at 324b-2 in the portal element 310b.

According to some embodiments, the issuance of the bond at 324a and/or the creation of the product package at 320a may cause, trigger, initiate, utilize, and/or otherwise be associated with a determination of payment options at 326a. The user may select, enter, define, and/or provide information descriptive of any practicable payment options and/or details, for example, such as credit card payment details, direct bill details, and/or agency bill details. In some embodiments, the payment options at 326a may cause, trigger, initiate, utilize, and/or otherwise be associated with a capturing of billing details at 326b in the portal element 310b, a bond payment service 326c-1 and/or a geo-coding service 326c-2 in the services element 310c. According to some embodiments, the geo-coding service 326c-2 may cause, trigger, initiate, utilize, and/or otherwise be associated with a diary service 326c-3. In some embodiments, the bond payment service 326c-1 may cause, trigger, initiate, utilize, and/or otherwise be associated with a direct billing system at 326d in the external element 310d. In some embodiments, the user may view and/or print (or export) the bond package at 328a. In some embodiments, the viewing/printing of the bond package at 328a may cause and/or initiate, for example, the triggering of the bond document service at 320b.

Turning now to FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, and FIG. 4Q, example user interfaces 410a-q according to some embodiments are shown. In some embodiments, the user interfaces 410a-q may comprise one or more web pages, web forms, database entry forms, API tools, spreadsheets, tables, and/or applications or other GUI tools via which a user may enter and/or retrieve data to conduct and/or facilitate an underwriting product pre-pricing, pricing, sales, and/or management processes. The user interfaces 410a-q may, for example, comprise a front-end of an underwriting product portal program and/or platform programmed and/or otherwise configured to execute, conduct, and/or facilitate the methods 300, 600 of FIG. 3 and/or FIG. 6 and/or portions or combinations thereof described herein. In some embodiments, the user interfaces 410a-q may be output via a computerized device such as one or more of the user devices 102a-n, 202a-b and/or the controller devices 104, 204 of FIG. 1 and/or FIG. 2 herein.

According to some embodiments, and referring specifically to FIG. 4A, a first user interface 410a may comprise one or more tabs and/or other segmented and/or logical-presented data forms and/or fields. In some embodiments, the first user interface 410a may be configured and/or organized to allow and/or facilitate login and/or access to an underwriting product portal as described herein. As depicted, for example, an area (e.g., one or more data entry mechanisms, tools, objects, and/or features) may be provided such that login credentials 412 descriptive of a specific user, user group, and/or user class may be entered. The login credentials 412 may comprise, for example, a user ID field 412-1 and/or a password field 412-2. According to some embodiments, the first user interface 410a may comprise a login button 414 that may, for example, initiate a transmission (e.g., from a user device; and attendant receipt by a controller device) of the login credentials 412. According to some embodiments, the login credentials 412 may be utilized to gain access to (and/or cause a providing of) one or more other user interfaces 410a-q.

In some embodiments, and referring specifically to FIG. 4B, a second user interface 410b may also or alternatively comprise one or more tabs and/or other segmented and/or logical-presented data forms and/or fields. In some embodiments, the second user interface 410b may be accessed via the first user interface 410a, such as by entering and/or submitting the login credentials 412. According to some embodiments, the second user interface 410b may be configured and/or organized to allow and/or facilitate a user to access one or more specific product and/or feature portals 416. As depicted, for example, an area (e.g., one or more data entry mechanisms, tools, objects, and/or features) may be provided such that a first portal option 416-1 (e.g., an “eBond” portal) or a second portal option 416-2 (e.g., a “Travelers Click™” portal) may be selected by a user. According to some embodiments, selection of the portal options 416 may be utilized to gain access to (and/or cause a providing of) one or more other user interfaces 410a-q.

According to some embodiments, and referring specifically to FIG. 4C, a third user interface 410c (e.g., a product portal landing page) may also or alternatively comprise one or more tabs and/or other segmented and/or logical-presented data forms and/or fields. In some embodiments, the third user interface 410c may be accessed via the second user interface 410b, such as by a selection of the second portal option 416-2 (e.g., the “Travelers Click™” portal). According to some embodiments, the third user interface 410c may be configured and/or organized to allow and/or facilitate a user to provide and/or retrieve information regarding an underwriting product, pre-price and/or price an underwriting product, sell an underwriting product, and/or otherwise manage an underwriting product. As depicted, for example, areas (e.g., one or more data entry mechanisms, tools, objects, and/or features) may be provided that allow, facilitate, and/or cause a user to access Work-In-Progress (WIP) button 420, customer details button 430, underwriting product details button 440 (e.g., a bond product as illustrated in the example), training information button 450, authority information button 452, notifications area 454, underwriter contact options area 456, a preference data area 458, and/or a product pricing button 460 (e.g., a “Start a Bond” button as depicted in the example). In some embodiments, the preference data area 458 may comprise an area where pre-determined and/or selected data types are presented to the user (e.g., WIP data as illustrated in the example). A user may set, select, define, and/or otherwise determine one or more preferences, filters, display options, data defaults, etc., for example, by selecting the “My Preferences” link 458-1. According to some embodiments, selection of any of the various areas and/or buttons 420, 430, 440, 450, 452, 454, 456, 458, 460 may be utilized to gain access to (and/or cause a providing of) one or more other user interfaces 410a-q.

In some embodiments, and referring specifically to FIG. 4D, a fourth user interface 410d may also or alternatively comprise one or more tabs and/or other segmented and/or logical-presented data forms and/or fields. In some embodiments, the fourth user interface 410d may be accessed via the third user interface 410c, such as by a selection of the WIP button 420. According to some embodiments, the fourth user interface 410d may be configured and/or organized to allow and/or facilitate a user to provide and/or retrieve information regarding WIP data. As depicted, for example, areas (e.g., one or more data entry mechanisms, tools, objects, and/or features) may be provided that allow a user to select the WIP data option 422, an active bonds option 424, an upcoming renewals option 426, and/or a search option 428. According to some embodiments, the WIP data option 422 may provide the user with WIP data 422-1 (which, in the ongoing example of the exemplary bond product portal, is the same as the data displayed in the preferred data area 458 of the landing page/third user interface 410c), the active bonds option 424 may cause a presentation of information descriptive of active (e.g., previously issued) bonds, the upcoming renewals option 426 may provide information descriptive of active bonds for which renewal actions are imminent, due, and/or otherwise relevant, and/or the search option 428 may allow querying of WIP data 422-1 and/or other bond or product data based on user-specified criteria. According to some embodiments, selection of any of the various areas and/or options 422, 424, 426, 428 may be utilized to gain access to (and/or cause a providing of) one or more other user interfaces 410a-q.

According to some embodiments, and referring specifically to FIG. 4E, a fifth user interface 410e may also or alternatively comprise one or more tabs and/or other segmented and/or logical-presented data forms and/or fields. In some embodiments, the fifth user interface 410e may be accessed via the fourth user interface 410d, such as by a selection of the upcoming renewals option 426. According to some embodiments, the fifth user interface 410e may be configured and/or organized to allow and/or facilitate a user to provide and/or retrieve information regarding upcoming bond renewal data 426-1. As depicted, for example, bond renewal data 426-1 may be provided to the user and/or provided in such a manner that the user may activate, cause display of, and/or otherwise achieve access to bond renewal detail data 426-2 (e.g., by selection and/or activation of an object, tool, and/or widget (e.g., a “twisty”) of the fifth user interface 410e).

In some embodiments, the fifth interface 410e may comprise a bond-level action drop-down menu 426-3. The bond-level action drop-down menu 426-3 may, in some embodiments, be dynamically and/or selectively populated to limit (and/or expand) the available menu options based on the particular bond renewal data 426-1 selected for action. As depicted in the example of FIG. 4E, for example, the bond (submission number “105630540”) for which the bond renewal detail data 426-2 is shown and the bond-level action drop-down menu 426-3 is selected may provide the options: (i) “Open” (e.g., open and view the submission package), (ii) “Open Change” (e.g., open and edit the submission package), (iii) “Edit Personnel” (e.g., view and/or alter the user(s) assigned to the selected submission package), (iv) “Issue Continuation” (e.g., issue, print, and/or export a continuation certificate for the bond), (v) “Issue Verification” (e.g., issue, print, and/or export a verification certificate for the bond), (vi) “Reprint Bond Package” (e.g., reprint the package for the bond—or a portion thereof), and/or (vii) “Request to Cancel” (e.g., request that the selected bond be cancelled). In some embodiments, options not available for a particular bond, bond type, etc. may not be presented in and/or may be actively removed from the bond-level action drop-down menu 426-3. The data populating the bond-level action drop-down menu 426-3, for example, may be customized for a particular bond, user, and/or scenario, such that unavailable actions and/or options are not presented, thus increasing efficiency for the user of the fifth interface 410e (and/or other interfaces 410a-q for which such a dynamic and/or “smart” bond-level action drop-down menu 426-3 is provided).

According to some embodiments, and referring specifically to FIG. 4F, a sixth user interface 410f may also or alternatively comprise one or more tabs and/or other segmented and/or logical-presented data forms and/or fields. In some embodiments, the sixth user interface 410f may be accessed via the fourth user interface 410d, such as by a selection of the search option 428. According to some embodiments, the sixth user interface 410f may be configured and/or organized to allow and/or facilitate a user to perform a search for WIP via a submission search window 428-1 or perform a search for active/issued bonds via a bond search window 428-2. A user may utilize either search window 428-1, 428-2, for example, to conduct a search that provides search results 428-3 via the sixth user interface 410f. In some embodiments, the search results 428-3 may comprise a bond-level action-item menu 428-3a that allows the user to select options available for a particular bond/submission (e.g., which may be similar to the bond-level action drop-down menu 426-3 of the fifth interface 410e). In some embodiments, the sixth user interface 410f may comprise a “My Preferences” link 428-4 that allows the user to set, define, and/or select one or more search (and/or other) preferences and/or defaults or options.

In some embodiments, and referring specifically to FIG. 4G, a seventh user interface 410g may also or alternatively comprise one or more tabs and/or other segmented and/or logical-presented data forms and/or fields. In some embodiments, the seventh user interface 410g may be accessed via the sixth user interface 410f, such as by a selection of the “My Preferences” link 428-4. According to some embodiments, the seventh user interface 410g may be configured and/or organized to allow and/or facilitate a user to set, define, select, and/or otherwise determine, via a preferences window 428-5, one or more preferences, options, and/or defaults. A first preferences option 428-5a may allow the user to define a default set of data for viewing, for example, a second preferences option 428-5b may allow the user to select a search criteria and/or filter, a third preference option 428-5c may allow the user to select a default bond parameter (e.g., which state default data should be provided for), and/or a fourth preference option 428-5d may allow the user to select a notification option related to bond package/submission cancellation requests.

According to some embodiments, and referring specifically to FIG. 4H, an eighth user interface 410h may also or alternatively comprise one or more tabs and/or other segmented and/or logical-presented data forms and/or fields. In some embodiments, the eighth user interface 410h may be accessed via the sixth user interface 410f, such as by a selection of an option from the bond-level action-item menu 428-3a (e.g., a “Change” and/or “Edit Personnel” option). According to some embodiments, the eighth user interface 410h may be configured and/or organized to allow and/or facilitate a user to set, define, select, and/or otherwise determine, via a personnel window 428-6, one or more assigned, default, and/or otherwise responsible personnel for the selected bond/submission. The user may set and/or select, for example, personnel for an Agency Processor 428-6a, an Attorney-In-Fact 428-6b, and/or a Licensed Producer 428-6c, assigned to the bond. In some embodiments, the Attorney-In-Fact 428-6b may comprise (and/or comprise a menu option for) a corporate, generic, default, blanket, and/or other Power-of-attorney.

In some embodiments, and referring specifically to FIG. 4I, a ninth user interface 410i may also or alternatively comprise one or more tabs and/or other segmented and/or logical-presented data forms and/or fields. In some embodiments, the ninth user interface 410i may be accessed via and/or comprise a different version of the sixth user interface 410f. According to some embodiments, the ninth user interface 410i may be configured and/or organized to allow and/or facilitate a user to set, define, select, and/or otherwise determine one or more advanced search criteria 428-1a, 428-1b. The submission search window 428-1 (and/or the bond search window 428-2) may comprise, for example, a set of first advanced search criteria 428-1a such as may allow the user to search a bond and/or submission utilizing a bond type, account name, obligee name, submission status, agency code, agency processor, licensed producer, and/or product category (e.g., via keyword and/or menu selection). In some embodiments, a set of second advanced search criteria 428-1b may comprise time and/or date range criteria to narrow and/or filter the search results to specific time and/or date ranges and/or other time-based characteristics (day of week, season, etc.).

According to some embodiments, and referring specifically to FIG. 4J, a tenth user interface 410j may also or alternatively comprise one or more tabs and/or other segmented and/or logical-presented data forms and/or fields. In some embodiments, the tenth user interface 410j may be accessed via the sixth user interface 410f, such as by a selection of an option from the bond-level action-item menu 428-3a (e.g., an “Issue Continuation Certificate” option). According to some embodiments, the tenth user interface 410j may be configured and/or organized to allow and/or facilitate a user to issue, print, export, and/or otherwise be provided with, via a continuation certificate window 428-7, a continuation certificate. In some embodiments, because data is shared in one or more shared-access repositories (and/or replicated into accessible copies of a data set) available to the user and an underwriter (e.g., “Lisa McDaniel” in the example of FIG. 4J), a continuation certificate may be issued and/or provided directly from the tenth user interface 410j, without the need for a personal request (e.g., telephone call and/or e-mail) to the underwriter. In the case that the user desires to obtain a continuation certificate (e.g., upon and/or after renewal of a bond) the user may utilize the continuation certificate window 428-7 to easily and quickly obtain the desired certificate. In some embodiments, such as in the case that the bond has not been renewed and/or is otherwise not authorized to receive a continuation certificate, the continuation certificate option and/or continuation certificate window 428-7 may not be available and/or provided.

In some embodiments, and referring specifically to FIG. 4K, an eleventh user interface 410k may also or alternatively comprise one or more tabs and/or other segmented and/or logical-presented data forms and/or fields. In some embodiments, the eleventh user interface 410k may be accessed via the sixth user interface 410f, such as by a selection of an option from the bond-level action-item menu 428-3a (e.g., an “Issue Verification Certificate” option). According to some embodiments, the eleventh user interface 410k may be configured and/or organized to allow and/or facilitate a user to issue, print, export, and/or otherwise be provided with, via a verification certificate window 428-8, a verification certificate. In some embodiments, because data is shared in one or more shared-access repositories (and/or replicated into accessible copies of a data set) available to the user and an underwriter (e.g., “Lisa McDaniel” in the example of FIG. 4K), a verification certificate may be issued and/or provided directly from the eleventh user interface 410k, without the need for a personal request (e.g., telephone call and/or e-mail) to the underwriter. In the case that the user desires to obtain a verification certificate (e.g., upon a request from a third-party) the user may utilize the verification certificate window 428-8 to easily and quickly obtain the desired certificate. In some embodiments, such as in the case that the bond is not in force and/or is otherwise not authorized to receive a verification certificate, the verification certificate option and/or verification certificate window 428-8 may not be available and/or provided

According to some embodiments, and referring specifically to FIG. 4L, a twelfth user interface 4101 may also or alternatively comprise one or more tabs and/or other segmented and/or logical-presented data forms and/or fields. In some embodiments, the twelfth user interface 4101 may be accessed via the third user interface 410c, such as by a selection of the customer details button 430. According to some embodiments, the twelfth user interface 4101 may be configured and/or organized to allow and/or facilitate a user to search for (and/or enter) customer information. As depicted, for example, areas (e.g., one or more data entry mechanisms, tools, objects, and/or features) may be provided that allow a user to select a search by name option 432, a search by bond number option 434, and/or a most recent option 436. As depicted in FIG. 4L, the search by name option 432 may be provided via a search by name window 432-1 that the user may utilize to conduct a search that provides search results 432-2 via the twelfth user interface 4101.

In some embodiments, and referring specifically to FIG. 4M, a thirteenth user interface 410m may also or alternatively comprise one or more tabs and/or other segmented and/or logical-presented data forms and/or fields. In some embodiments, the thirteenth user interface 410m may be accessed via the third user interface 410c, such as by a selection of the customer details button 430. According to some embodiments, the thirteenth user interface 410m may be configured and/or organized to allow and/or facilitate a user to search for (and/or enter) customer information. As depicted, for example, areas (e.g., one or more data entry mechanisms, tools, objects, and/or features) may be provided that allow a user to select a search by name option 432, a search by bond number option 434, and/or a most recent option 436. As depicted in FIG. 4M, the most recent option 436 may be provide search results 432-2 via the twelfth user interface 4101, the search results 432-2 comprising a listing of the most recently utilized (e.g., viewed, worked on, submitted) bonds, underwriting products, submissions, packages, etc.

In some embodiments, and referring specifically to FIG. 4N, a fourteenth user interface 410n may also or alternatively comprise one or more tabs and/or other segmented and/or logical-presented data forms and/or fields. In some embodiments, the fourteenth user interface 410n may be accessed via the third user interface 410c, such as by a selection of the underwriting product (e.g., bond) details button 440. According to some embodiments, the fourteenth user interface 410n may be configured and/or organized to allow and/or facilitate a user to search for information regarding available bond (and/or other underwriting) products. As depicted, for example, areas (e.g., one or more data entry mechanisms, tools, objects, and/or features) may be provided that allow a user to select a search option 442 and/or a most recent option 444. As depicted in FIG. 4N, the search option 442 may be provided via a search window 442-1 that the user may utilize to conduct a search (e.g., a keyword search) that provides search results 442-2 via the fourteenth user interface 410n.

In some embodiments, one or more pricing options 446 may be provided in conjunction with the search results 442-1, allowing access to pricing information regarding any particular bond product within the search results 442-2. According to some embodiments, the pricing options 446 may allow a user to obtain pre-pricing, estimate, and/or preliminary price indications (e.g., a range, minimum, average, and/or mean) for a selected bond/package/submission and/or other product. Preliminary bond information, such as the state, type, limit, etc., may be utilized by the fourteenth user interface 410n (and/or a system operating the fourteenth user interface 410n), for example, to provide such preliminary price estimates and/or indications. In some embodiments, the fourteenth user interface 410n may comprise individual product (e.g., bond) pricing buttons 460-1 that permit initiation of full-pricing, underwriting, quotation and/or sales activities for any specific bond product within the search results 442-2. The pricing buttons 460-1 may allow entry of data in addition to any preliminary bond data, for example, to arrive at a more accurate, final, and/or otherwise non-preliminary price quote, estimate, and/or indication.

In some embodiments, and referring specifically to FIG. 4O, a fifteenth user interface 410o may also or alternatively comprise one or more tabs and/or other segmented and/or logical-presented data forms and/or fields. In some embodiments, the fifteenth user interface 410o may be accessed via the third user interface 410c, such as by a selection of the training information button 450. According to some embodiments, the fifteenth user interface 410o may be configured and/or organized to allow and/or facilitate a user to access online and/or stored training materials, such as via links and/or information provided by a training access window 450-1. In some embodiments, in addition to and/or as part of the available training options, an underwriter direct-contact button 456-1 may be provided (e.g., to allow the user to directly contact an underwriter to get questions answered).

According to some embodiments, and referring specifically to FIG. 4P, a sixteenth user interface 410p may also or alternatively comprise one or more tabs and/or other segmented and/or logical-presented data forms and/or fields. In some embodiments, the sixteenth user interface 410p may be accessed via the fifteenth user interface 410o, such as by a selection of the underwriter direct-contact button 456-1. According to some embodiments, the sixteenth user interface 410p may be configured and/or organized to allow and/or facilitate a user to send an e-mail (and/or other) communication to an underwriter and/or training assistance personnel via links, menu items, and/or tools or features of an e-mail window 450-2.

In some embodiments, and referring specifically to FIG. 4Q, a seventeenth user interface 410q may also or alternatively comprise one or more tabs and/or other segmented and/or logical-presented data forms and/or fields. In some embodiments, the seventeenth user interface 410q may be accessed via the third user interface 410c, such as by a selection of the authority information button 452. According to some embodiments, the seventeenth user interface 410q may be configured and/or organized to allow and/or facilitate a user to access authority information. Whereas authority information is typically not easily accessible, for example, the seventeenth user interface 410q may provide quick and/or convenient access to authority information. In some embodiments, this may reduce the occurrence of and/or prevent deviations from the approved authority limits for an agency, agent, account, etc. Particularly in the case that authority deviations may result in serious penalties and/or consequences, avoiding such adverse consequences by providing easy access to the authority information may be quite beneficial. In some embodiments, the authority information may be available via an agency authority tab 452a and/or an account authority tab 452b (e.g., allowing easy access to agency-level and account-level authority limits, respectively). The agency authority tab 452a may, in some embodiments, comprise a selectable listing of available agencies 452a-1 and/or a listing of authority limits 452a-2.

Referring now to FIG. 5A, FIG. 5B, FIG. 5C, FIG. 5D, FIG. 5E, FIG. 5F, FIG. 5G, FIG. 5H, FIG. 5I, FIG. 5J, FIG. 5K, and FIG. 5L, example user interfaces 510a-1 according to some embodiments are shown. In some embodiments, the user interfaces 510a-1 may comprise one or more web pages, web forms, database entry forms, API tools, spreadsheets, tables, and/or applications or other GUI tools via which a user may enter and/or retrieve data to conduct and/or facilitate an underwriting product pre-pricing, pricing, sales, and/or management processes. The user interfaces 510a-1 may, for example, comprise a front-end of an underwriting product portal program and/or platform programmed and/or otherwise configured to execute, conduct, and/or facilitate the methods 300, 600 of FIG. 3 and/or FIG. 6 and/or portions or combinations thereof described herein. In some embodiments, the user interfaces 510a-1 may be output via a computerized device such as one or more of the user devices 102a-n, 202a-b and/or the controller devices 104, 204 of FIG. 1 and/or FIG. 2 herein. In some embodiments, the user interfaces 510a-1 may be part of, related to, accessible via, and/or otherwise associated with any or all of the user interfaces 410a-q.

According to some embodiments, and referring specifically to FIG. 5A for example, upon activation and/or selection of the product pricing button 460 (and/or any individual product pricing button 460-1) of the user interfaces 410a-q, a first user interface 510a may be provided to a user. The first user interface 510a may, for example, comprise a bond process screen 562 that may, for example, comprise a bond process timeline 564 with a bond type and customer progress indicator 564-1. In some embodiments, the bond process screen 562 may allow a user to conduct a bond product type search 566 (and/or other underwriting product or product type search) and/or enter and/or search for customer data 568 (e.g., to be associated with a particular product). As shown in more detail in FIG. 5B, a second user interface 510b depicts an entry of a keyword search term 566-1 that is utilized to initiate a query providing search results 566-2, from which one or more desired bond (and/or other) products may be selected.

In some embodiments, and referring specifically to FIG. 5C, upon activation and/or selection of a particular product from the search results 566-2, a third user interface 510c may be provided to the user. The third user interface 510c may, for example, indicate (e.g., via a check mark on and/or associated with the bond type search 566 tab and/or element) that the bond product type search 566 and/or product selection has been completed and/or may allow entry and/or retrieval of the customer data 568. The customer data 568 may comprise, for example, account data 568-1, principal data 568-2, and/or agency data 568-3.

According to some embodiments, and referring specifically to FIG. 5D, upon completion of the bond type search 566 and/or the customer data 568 (e.g., indicated by a check mark on the bond type and customer progress indicator 564-1), a fourth user interface 510d may be provided to the user. The fourth user interface 510d may, for example, show a bond details progress indicator 564-2 and/or may allow entry of data descriptive of bond (and/or other product) details 570 and/or data descriptive of underwriting data 572. The data descriptive of the bond details 570 may comprise, for example, product data 570-1, limit data 570-2, obligee data 570-3, term data 570-4, and/or asset data 570-5.

In some embodiments, and referring specifically to FIG. 5E, upon completion of the bond details 570, a fifth user interface 510e may be provided to the user. The fifth user interface 510e may, for example, indicate (e.g., via a check mark on and/or associated with the bond details 570 tab and/or element) that the bond details 570 data has been entered and/or may allow entry of underwriting data 572. The underwriting data 572 may comprise, for example, a plurality of underwriting questions 572-1 that may, for example, be specific to a particular bond, customer, agent, etc.

According to some embodiments, and referring specifically to FIG. 5F, upon completion of the bond details 570 and/or the underwriting data 572 (e.g., indicated by a check mark on the bond details progress indicator 564-2), a sixth user interface 510f may be provided to the user. The sixth user interface 510f may, for example, show an underwriting decision progress indicator 564-3 and/or may provide data descriptive of an underwriting decision 574. The data descriptive of the underwriting decision 574 (e.g., “APPROVED” in the example) may comprise, in some embodiments, obligee data 574-1, current billing term data 574-2, limit data 574-3, total premium data 574-4, total commission data 547-5, and/or premium detail data 574-6.

In some embodiments, and referring specifically to FIG. 5G, upon completion and/or acceptance of the underwriting decision 574 (e.g., indicated by a check mark on the underwriting decision progress indicator 564-3), a seventh user interface 510g may be provided to the user. The seventh user interface 510g may, for example, show a bill and issue progress indicator 564-4 and/or may provide and/or allow entry or selection of billing information 576 and/or package issuance information 578. The billing information 576 may provide a user an opportunity, for example, to direct bill 576-1 a customer for the bond to be issued.

According to some embodiments, and referring specifically to FIG. 5H, upon (and/or as part of) completion and/or acceptance of the billing information 576, an eighth user interface 510h may be provided to the user. The eighth user interface 510h may, for example, provide a payment details window 576-1 that allows the user to select, define, and/or enter various payment information such as in relation to credit card billing 576-1a and/or direct billing 576-1b.

In some embodiments, and referring specifically to FIG. 5I, upon (and/or as part of) completion and/or acceptance of the billing information 576 and/or the credit card billing 576-1a, a ninth user interface 510i may be provided to the user. The ninth user interface 510i may, for example, provide a payment details verification window 576-2 that allows the user to review billing and/or payment information such as credit card billing information 576-2a. In some embodiments, a payment information edit link 576-2b may be provided to, for example, allow the user to easily return to the eighth user interface 510h and/or the payment details window 576-1 (e.g., to edit the information in relation to the credit card billing 576-la and/or to switch to direct billing 576-1b).

According to some embodiments, and referring specifically to FIG. 5J, upon (and/or as part of) completion and/or acceptance of the billing information 576, a tenth user interface 510j may be provided to the user. The tenth user interface 510j may, for example, provide an agency bill window 576-3 that allows the user to select, define, edit, and/or enter various payment information such as in relation to agency billing contacts, addresses, etc.

In some embodiments, and referring specifically to FIG. 5K, upon completion and/or acceptance of the billing information 576 (e.g., via a check mark on and/or associated with the billing information 576 tab and/or element), an eleventh user interface 510k may be provided to the user. The eleventh user interface 510k may, for example, allow the user to enter and/or retrieve package issuance information 578. As depicted in FIG. 5K, for example, the user may choose to supply their own forms 578-1, enter data and/or complete required forms 578-2, and/or select a preview bond package button 580. In some embodiments, once the user is prepared and/or all required data and forms are complete, the user may cause the bond to issue 590 (and/or request that the bond be issued 590).

According to some embodiments, and referring specifically to FIG. 5L, upon completion and/or acceptance of the billing information 576 and/or the package issuance information 578 (e.g., indicated by a check mark on the bill and issue progress indicator 564-4) and/or upon selection and/or request for bond issuance 590, a twelfth user interface 5101 may be provided to the user. The twelfth user interface 5101 may, for example, show a print package progress indicator 564-5 and/or may provide and/or allow entry or selection of package finalization information 592. The package finalization information 592 may, for example, allow a user to view the final bond package 592-1, print a credit card receipt 592-2 (and/or other accounting record), and/or upload documents 594 (e.g., documents that have already been executed by a customer). In some embodiments, the user may select an exit button 596 to end the bond (and/or other product) pricing and/or sales process and/or may choose a new product pricing button 560-2 to begin a new pricing and/or sales process.

While the example user interfaces 410a-q, 510a-1 are depicted herein with respect to a specific example of a bond product portal, other products, portals, searches, and/or other functionalities may be provided in accordance with some embodiments. While the depicted underwriting product comprises a bond product, for example, other underwriting products such as insurance and/or surety products may also or alternatively be utilized by and/or incorporated into the user interfaces 410a-q, 510a-1.

While various components of the interfaces 410a-q, 510a-l of FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and FIG. 5L have been described with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning to FIG. 6, a flow diagram of a method 600 according to some embodiments is shown. In some embodiments, the method 600 may be performed and/or implemented by and/or otherwise associated with one or more specialized and/or computerized processing devices (e.g., the user devices 102a-n, 202a-b and/or the controller device 104, 204 of FIG. 1 and/or FIG. 2), specialized computers, computer terminals, computer servers, computer systems and/or networks, and/or any combinations thereof (e.g., by one or more insurance company, agent/broker, and/or bond underwriter computers). In some embodiments, the method 600 may be embodied in, facilitated by, and/or otherwise associated with various input mechanisms and/or interfaces such as the example interfaces 410a-q, 510a-l of FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L, herein. In some embodiments, the method 600 may comprise and/or otherwise be associated with the method 300 of FIG. 3 herein, and/or one or more portions thereof.

In some embodiments, the method 600 may comprise receiving (e.g., by a specially-programmed computerized processing device and/or from a device of a user) preliminary bond (and/or other underwriting product) information descriptive of a desired bond product, at 602. Preliminary bond information may comprise, for example, an indication of one or more of: user information, desired bond type, desired bond limit, desired term option, and/or an indication of a state (or other jurisdiction) in which the bond is desired to be issued. In some embodiments, the preliminary bond information may be received from a user and/or retrieved in association with a user (e.g., from a database record configured in relation to the user). An agent, customer (and/or potential customer), CSR, broker, and/or other entity may utilize a network device such as a mobile computing device, for example, to provide, define, identify, and/or otherwise cause and/or facilitate a determination of the preliminary bond information. In some embodiments, the preliminary bond information may comprise one or more preferences and/or defaults previously defined by and/or for the user. In some embodiments, the preliminary bond information may comprise information provided prior to initiation of a bond package and/or underwriting product submission.

According to some embodiments, the method 600 may comprise determining (e.g., by the specially-programmed computerized processing device and/or based on the preliminary bond information descriptive of the desired bond product) a price indication for the desired bond product, at 604. One or more stored rules may be utilized, for example, to determine a preliminary price indication, estimate, and/or quote—e.g., based on the preliminary bond information. In some embodiments, the preliminary bond information may be utilized to lookup and/or calculate the price indication. In some embodiments, the price indication may comprise a minimum, maximum, average, likely (e.g., estimated), and/or other preliminary price based on the preliminary bond information. In some embodiments, the price indication may comprise a range or baseline (e.g., with or without fees, taxes, and/or surcharges). In some embodiments, the price indication may be calculated based on stored data descriptive of the preliminary bond information.

In some embodiments, the method 600 may comprise providing (e.g., by the specially-programmed computerized processing device and/or to the device of the user) an indication of the price indication for the desired bond product, at 606. The price indication may, for example, be transmitted to and/or may be caused to be displayed on a device of the user (e.g., a smart phone and/or tablet display screen). In such a manner, for example, preliminary pricing information may be obtained and/or utilized by a user to determine whether time and effort should be spent organizing, constructing, and/or defining a complete quotation package for the desired bond. In the case that the preliminary pricing is higher than the user desires, for example, the user may decide to pursue a different bond. In the case that the pricing indication is within desired limits and/or expectations of the user, the user may continue to initiate and/or prepare a full and/or complete bond (and/or other underwriting product) submission package.

According to some embodiments, the method 600 may comprise facilitating (e.g., by the specially-programmed computerized processing device and/or after the providing) a sale of the desired bond product, at 608. In the case that the user desires to apply for the bond, for example, the user may initiate, identify, define, and/or construct or complete a full submission package. In some embodiments, the preliminary bond information may be passed to a program utilized to prepare the bond package, such as to save time by reducing the need for duplicate entry of data.

In some embodiments, the method 600 and/or the facilitating of the sale of the product (e.g., at 608) may comprise providing an underwriting decision to the user. In some embodiments, the underwriting decision may be provided in real-time and/or during a bond package creation session initiated by the user via a user interface and/or bond portal program, software, and/or application. According to some embodiments for example, data stored in a jointly-accessible manner with respect to both the user and the underwriter (e.g., in a single shared data store or in replicated or duplicated data stores) may permit the underwriter to quickly and easily access product package information and formulate a decision. Similarly, the decision may be quickly routed and/or provided to the user (e.g., via the bond portal interface and/or during a single login session of the user).

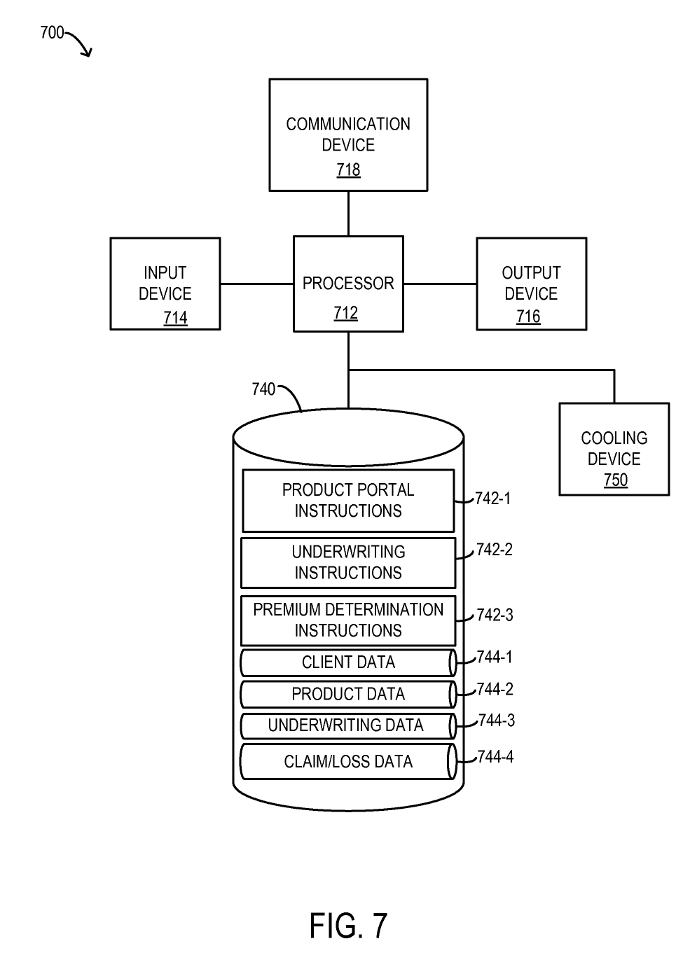

Referring now to FIG. 7, a block diagram of an apparatus 700 according to some embodiments is shown. In some embodiments, the apparatus 700 may be similar in configuration and/or functionality to user devices 102a-n, 202a-b, and/or the controller devices 104, 204 of FIG. 1 and/or FIG. 2 herein. The apparatus 700 may, for example, execute, process, facilitate, and/or otherwise be associated with the methods 300, 600 of FIG. 3 and/or FIG. 6, and/or may output or provide the user interfaces 410a-q, 510a-1 of FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L, herein. In some embodiments, the apparatus 700 may comprise an electronic processor 712, an input device 714, an output device 716, a communication device 718, a memory device 740, and/or a cooling device 750. Fewer or more components 712, 714, 716, 718, 740, 750 and/or various configurations of the components 712, 714, 716, 718, 740, 750 may be included in the apparatus 700 without deviating from the scope of embodiments described herein.

According to some embodiments, the electronic processor 712 may be or include any type, quantity, and/or configuration of electronic and/or computerized processor that is or becomes known. The electronic processor 712 may comprise, for example, an Intel® IXP 2800 network processor or an Intel® XEON™ Processor coupled with an Intel® E7501 chipset. In some embodiments, the electronic processor 712 may comprise multiple inter-connected processors, microprocessors, and/or micro-engines. According to some embodiments, the electronic processor 712 (and/or the apparatus 700 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 700 comprises a server such as a blade server, necessary power may be supplied via a standard AC outlet, power strip, surge protector, and/or Uninterruptible Power Supply (UPS) device.

In some embodiments, the input device 714 and/or the output device 716 are communicatively coupled to the electronic processor 712 (e.g., via wired and/or wireless connections, traces, and/or pathways) and they may generally comprise any types or configurations of input and output components and/or devices that are or become known, respectively. The input device 714 may comprise, for example, a keyboard that allows an operator of the apparatus 700 to interface with the apparatus 700 (e.g., an underwriter, agent, broker, customer (and/or potential customer), and/or a CSR, such as to implement and/or interact with embodiments herein to underwrite, pre-price, quote, manage, and/or sell underwriting products). The output device 716 may, according to some embodiments, comprise a display screen and/or other practicable output component and/or device. The output device 716 may, for example, provide underwriting product pre-pricing indications and/or quotes, training, and/or authority information (e.g., via a website and/or via a computer workstation). According to some embodiments, the input device 714 and/or the output device 716 may comprise and/or be embodied in a single device such as a touch-screen monitor.

In some embodiments, the communication device 718 may comprise any type or configuration of communication device that is or becomes known or practicable. The communication device 718 may, for example, comprise a Network Interface Card (NIC), a telephonic device, a cellular network device, a router, a hub, a modem, and/or a communications port or cable. In some embodiments, the communication device 718 may be coupled to provide data to a customer device, such as in the case that the apparatus 700 is utilized to provide underwriting product pre-pricing indications, quotations and/or sales. According to some embodiments, the communication device 718 may also or alternatively be coupled to the electronic processor 712. In some embodiments, the communication device 718 may comprise an IR, RF, Bluetooth™, NFC, and/or Wi-Fi® network device coupled to facilitate communications between the electronic processor 712 and another device (such as a customer device and/or a third-party device).

The memory device 740 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 740 may, according to some embodiments, store one or more of product portal instructions 742-1, underwriting instructions 742-2, and/or premium determination instructions 742-3. In some embodiments, the product portal instructions 742-1, underwriting instructions 742-2, and/or premium determination instructions 742-3 may be utilized by the electronic processor 712 to provide output information via the output device 716 and/or the communication device 718 (e.g., the launching of the bond portal at 312a of the method 300 of FIG. 3 and/or the providing of the interface(s) 410a-q, 510a-l of FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L, herein).

According to some embodiments, the product portal instructions 742-1 may be operable to cause the electronic processor 712 to access client data 744-1, product data 744-2, underwriting data 744-3, and/or claim/loss data 744-4 (e.g., in accordance with the methods 300, 600 of FIG. 3 and/or FIG. 6 herein). Client data 744-1, product data 744-2, underwriting data 744-3, and/or claim/loss data 744-4 received via the input device 714 and/or the communication device 718 may, for example, be analyzed, sorted, filtered, decoded, decompressed, ranked, scored, plotted, and/or otherwise processed by the electronic processor 712 in accordance with the product portal instructions 742-1. In some embodiments, client data 744-1, product data 744-2, underwriting data 744-3, and/or claim/loss data 744-4 may be fed by the electronic processor 712 through one or more mathematical and/or statistical formulas, rule sets, policies, software routines and/or modules and/or models in accordance with the product portal instructions 742-1 to provide the user interfaces 410a-q, 510a-l of FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P, FIG. 4Q, FIG. 5A, FIG. 5B, FIG. 5C, FIG. 5D, FIG. 5E, FIG. 5F, FIG. 5G, FIG. 5H, FIG. 5I, FIG. 5J, FIG. 5K, and/or FIG. 5L, as described herein.

According to some embodiments, the underwriting instructions 742-2 may be operable to cause the electronic processor 712 to access the client data 744-1, product data 744-2, underwriting data 744-3, and/or claim/loss data 744-4 (e.g., in accordance with the methods 300, 600 of FIG. 3 and/or FIG. 6 herein). Client data 744-1, product data 744-2, underwriting data 744-3, and/or claim/loss data 744-4 received via the input device 714 and/or the communication device 718 may, for example, be analyzed, sorted, filtered, decoded, decompressed, ranked, scored, plotted, and/or otherwise processed by the electronic processor 712 in accordance with the underwriting instructions 742-2. In some embodiments, client data 744-1, product data 744-2, underwriting data 744-3, and/or claim/loss data 744-4 may be fed by the electronic processor 712 through one or more mathematical and/or statistical formulas, rule sets, policies, software routines and/or modules and/or models in accordance with the underwriting instructions 742-2 to determine one or more underwriting questions, criteria, decisions, and/or requirements that may then be utilized to facilitate product pre-pricing and/or underwriting as described herein.

According to some embodiments, the premium determination instructions 742-3 may be operable to cause the electronic processor 712 to access client data 744-1, product data 744-2, underwriting data 744-3, and/or claim/loss data 744-4 (e.g., in accordance with the methods 300, 600 of FIG. 3 and/or FIG. 6 herein). Client data 744-1, product data 744-2, underwriting data 744-3, and/or claim/loss data 744-4 received via the input device 714 and/or the communication device 718 may, for example, be analyzed, sorted, filtered, decoded, decompressed, ranked, scored, plotted, and/or otherwise processed by the electronic processor 712 in accordance with the premium determination instructions 742-3 In some embodiments, client data 744-1, product data 744-2, underwriting data 744-3, and/or claim/loss data 744-4 may be fed by the electronic processor 712 through one or more mathematical and/or statistical formulas, rule sets, policies, software routines and/or modules and/or models in accordance with the premium determination instructions 742-3 to determine a pre-pricing indication and/or a quote (e.g., in accordance with the methods 300, 600 of FIG. 3 and/or FIG. 6 herein) that may then be utilized to facilitate product underwriting and/or sales as described herein.

In some embodiments, the memory device 740 may store the claim/loss data 744-4. The claim/loss data 744-4 may, for example, comprise data obtained from determining loss information such as may be based on one or more loss and/or default events associated with a customer and/or product. The claim/loss data 744-4 may, according to some embodiments, be utilized to update, modify, and/or otherwise influence or affect the various calculations and/or processes described herein. The input device 714 and/or the communication device 718 may receive the claim/loss data 744-4, which may be stored (as depicted in FIG. 7) by the memory device 740 and/or which may be processed by the electronic processor 712 in accordance with stored instructions (not explicitly shown in FIG. 7), such as to modify one or more of the product portal instructions 742-1, underwriting instructions 742-2, and/or premium determination instructions 742-3.

According to some embodiments, the apparatus 700 may generally function as a computer terminal and/or server of an insurance, bond, and/or surety underwriting company, for example, which is utilized to process various insurance, bond, surety, and/or other underwriting product applications. In some embodiments, the apparatus 700 may comprise a web server and/or other portal (e.g., an Interactive Voice Response Unit (IVRU)) that provides underwriting and/or product pricing (and/or pre-pricing) information to customers and/or third-parties.

Any or all of the exemplary instructions and data types described herein and other practicable types of data may be stored in any number, type, and/or configuration of memory devices that is or becomes known. The memory device 740 may, for example, comprise one or more data tables or files, databases, table spaces, registers, and/or other storage structures. In some embodiments, multiple databases and/or storage structures (and/or multiple memory devices 740) may be utilized to store information associated with the apparatus 700. According to some embodiments, the memory device 740 may be incorporated into and/or otherwise coupled to the apparatus 700 (e.g., as shown) or may simply be accessible to the apparatus 700 (e.g., externally located and/or situated).

In some embodiments, the apparatus 700 may comprise the cooling device 750. According to some embodiments, the cooling device 750 may be coupled (physically, thermally, and/or electrically) to the electronic processor 712 and/or to the memory device 740. The cooling device 750 may, for example, comprise a fan, heat sink, heat pipe, radiator, cold plate, and/or other cooling component or device or combinations thereof, configured to remove heat from portions or components of the apparatus 700.

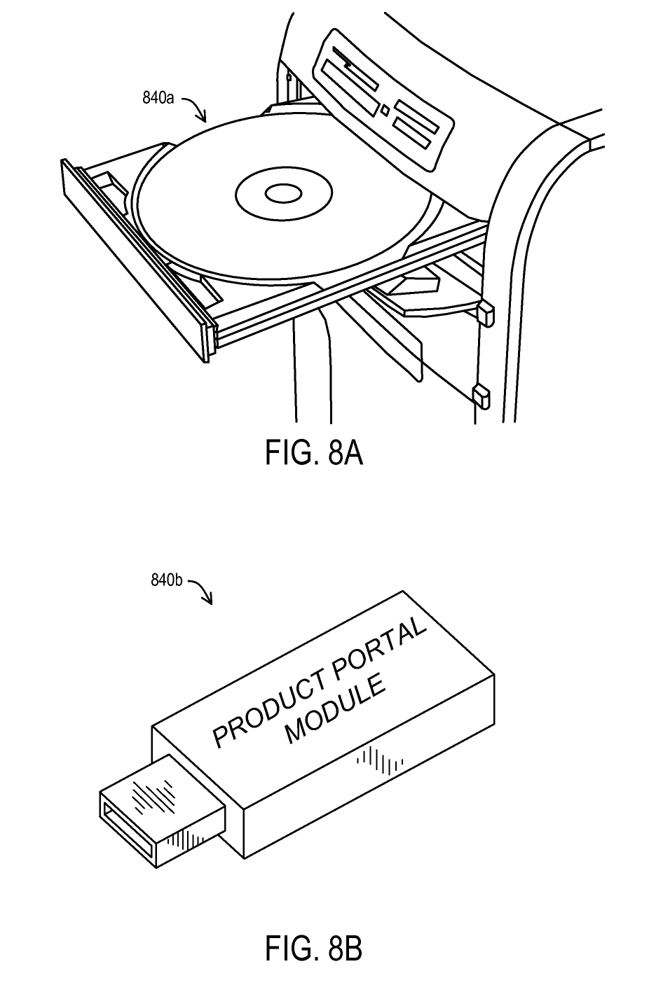

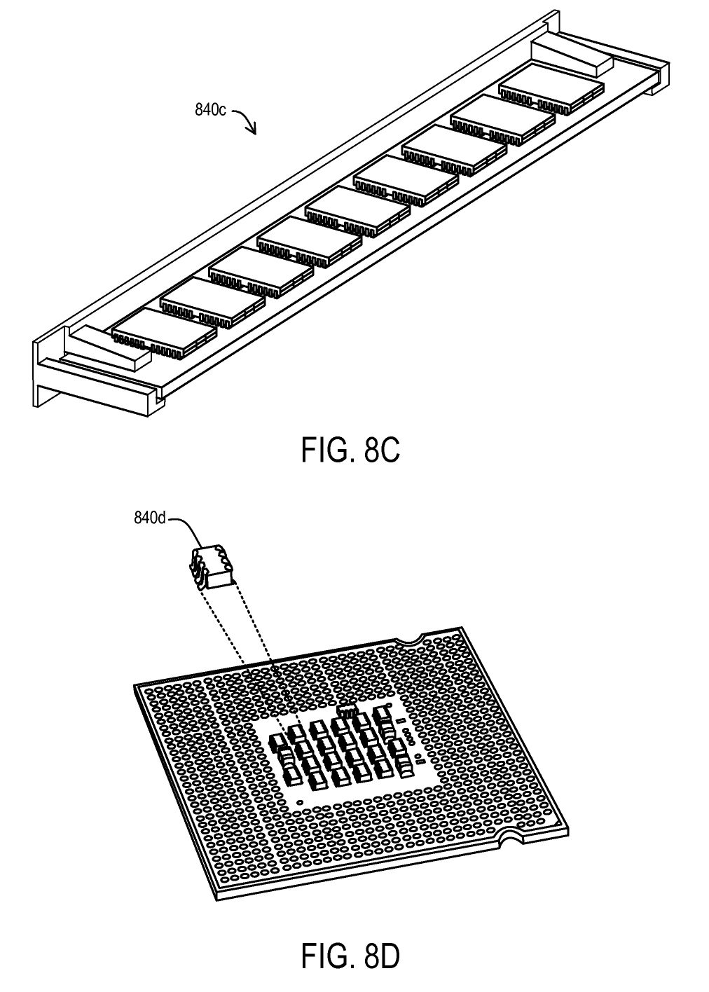

Referring to FIG. 8A, FIG. 8B, FIG. 8C, and FIG. 8D, perspective diagrams of exemplary data storage devices 840a-d according to some embodiments are shown. The data storage devices 840a-d may, for example, be utilized to store instructions and/or data such as the product portal instructions 742-1, underwriting instructions 742-2, and/or premium determination instructions 742-3, each of which is described in reference to FIG. 7 herein. In some embodiments, instructions stored on the data storage devices 840a-d may, when executed by a processor (such as the electronic processor 712 of FIG. 7), cause the implementation of and/or facilitate the methods 300, 600 of FIG. 3 and/or FIG. 6 (or portions thereof) described herein. The data storage devices 840a-db may also or alternatively store data such as the client data 744-1, product data 744-2, underwriting data 744-3, and/or claim/loss data 744-4, all as described with reference to FIG. 7 herein.

According to some embodiments, the first data storage device 840a may comprise a CD, CD-ROM, DVD, Blu-Ray™ Disc, and/or other type of optically-encoded disk and/or other computer-readable storage medium that is or becomes know or practicable. In some embodiments, the second data storage device 840b may comprise a USB keyfob, dongle, and/or other type of flash memory data storage device that is or becomes know or practicable. According to some embodiments, the third data storage device 840c may comprise RAM of any type, quantity, and/or configuration that is or becomes practicable and/or desirable. In some embodiments, the third data storage device 840c may comprise an off-chip cache such as a Level 2 (L2) or Level 3 (L3) cache memory device. According to some embodiments, the fourth data storage device 840d may comprise an on-chip memory device such as a Level 1 (L1) cache memory device.

The data storage devices 840a-d may generally store program instructions, code, and/or modules that, when executed by an electronic and/or computerized processing device cause a particular machine to function in accordance with embodiments described herein. In some embodiments, the data storage devices 840a-d depicted in FIG. 8A, FIG. 8B, FIG. 8C, and FIG. 8D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of non-transitory computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

what is claimed is:

1. A method, comprising:
receiving, by a specially-programmed computerized processing device and from a device of a user, preliminary bond information descriptive of a desired bond product;
determining, by the specially-programmed computerized processing device and based on the preliminary bond information descriptive of the desired bond product, a price indication for the desired bond product;
providing, by the specially-programmed computerized processing device and to the device of the user, an indication of the price indication for the desired bond product; and
facilitating, by the specially-programmed computerized processing device and after the providing, a sale of the desired bond product.

2. The method of claim 1, wherein the device of the user comprises a wireless mobile device and the receiving of the preliminary bond information is conducted via a wireless network.

3. The method of claim 1, wherein the preliminary bond information comprises information descriptive of the user.

4. The method of claim 1, wherein the user comprises one or more of a bond agent, a bond broker, a bond underwriter, a bond underwriter entity customer service representative, and a bond customer.

5. The method of claim 1, wherein the determining of the price indication for the desired bond product, comprises:
applying one or more stored rules to the preliminary bond information descriptive of the desired bond product.

6. The method of claim 1, wherein the price indication for the desired bond product comprises a range of likely prices for the desired bond product.

7. The method of claim 1, wherein the price indication for the desired bond product comprises a baseline price for the desired bond product.

8. The method of claim 7, wherein the baseline price for the desired bond product does not include one or more of taxes, fees, and surcharges.

9. The method of claim 1, wherein the price indication for the desired bond product comprises a minimum possible price for the desired bond product.

10. The method of claim 1, wherein the preliminary bond information comprises an indication of one or more of: (i) a bond limit; (ii) a bond type; (iii) a state in which the bond is sought; and (iv) a term option.

11. The method of claim 10, wherein the preliminary bond information comprises information descriptive of a preference of the user, and wherein the one or more of (i) the bond limit, (ii) the bond type, (iii) the state in which the bond is sought, and (iv) the term option is derived from the user preference.

12. The method of claim 1, wherein the providing of the indication of the price indication for the desired bond product occurs prior to receiving any bond information with respect to the desired bond product other than the preliminary bond information.

13. The method of claim 1, wherein the providing comprises:
causing a display device of the user device to output the indication of the price indication for the desired bond product.

14. The method of claim 1, wherein the facilitating of the sale of the desired bond product, comprises:
passing the preliminary bond information to a bond package creation process; and
initiating the bond package creation process.

15. The method of claim 14, wherein the passing of the preliminary bond information to the bond package creation process, comprises:
storing the preliminary bond information in a database accessible to both the user and an underwriter.

16. The method of claim 14, wherein the facilitating of the sale of the desired bond product, further comprises:
providing, upon completion of the bond package creation process and to the user, an underwriting acceptance decision for the desired bond product; and
receiving, from the device of the user, an indication of a payment for the approved bond product.

17. A computer-readable memory storing instructions that when executed by a processing device result in:
receiving, from a device of a user, preliminary bond information descriptive of a desired bond product;
determining, based on the preliminary bond information descriptive of the desired bond product, a price indication for the desired bond product;
providing, to the device of the user, an indication of the price indication for the desired bond product; and
facilitating, after the providing, a sale of the desired bond product.

18. The computer-readable memory of claim 17, wherein the providing of the indication of the price indication for the desired bond product occurs prior to receiving any bond information with respect to the desired bond product other than the preliminary bond information.

19. A system, comprising:
a shared database;
an underwriter terminal in communication with the shared database; and
a controller device in communication with the shared database, the controller device being configured to execute stored instructions that result in:
receiving, by the controller device and from a device of a user, preliminary bond information descriptive of a desired bond product;
determining, by the controller device and based on the preliminary bond information descriptive of the desired bond product and based on underwriting rules stored in the shared database, a price indication for the desired bond product;
providing, by the controller device and to the device of the user, an indication of the price indication for the desired bond product;
storing, by the controller device, the preliminary bond information in the shared database; and
causing the underwriting terminal to provide, based at least in part on an accessing of the preliminary bond information stored in the shared database, a real-time underwriting decision to the user.

20. The system of claim 19, further comprising an application running on the device of the user, the application configured to execute instructions stored on the device of the user that result in a transmitting of the preliminary bond information to the controller device.
